(19) United States
(12) Patent Application Publication
(10) Pub. No.: US 2014/0095285 A1
(43) Pub. Date: Apr. 3, 2014

(54) SYSTEM FOR AUTOMATING CONSUMER SHOPPING PURCHASE-DECISION

(71) Applicant: MOTYX INCORPORATED, Wayne, PA (US)

(72) Inventors: Aaron L. Wadell, Wayne, PA (US); Kevin J. Young, Havertown, PA (US)

(73) Assignee: MOTYX INCORPORATED, WAYNE, PA (US)

(21) Appl. No.: 13/661,075

(22) Filed: Oct. 26, 2012

Related U.S. Application Data
(63) Continuation of application No. PCT/US2012/000426, filed on Oct. 3, 2012.

(51) Int. Cl. G06Q 30/00

(52) U.S. Cl. 705/14.25; 705/26.8; 705/26.7; 705/14.33

(57) ABSTRACT

A method comprises: (a) receiving from a mobile device (MD) a first list identifying an item and a store list identifying a store. The first list of items at each store represents a basket; (b) for each store, performing in a computer remote from the MD a comparison calculation among baskets. The calculation is performed at the category or lower level, identifying a combination of commercial substitutes or at least SKU's, corresponding to items in the basket, that best satisfies the comparison calculation for each basket; (c) after step (b), receiving from a computer implemented direct marketing campaign management system, a retail incentive offer; and (d) after step (c), transmitting to the MD identification of a recommended store, or a second list containing a set of respective SKU level descriptors that best satisfy the comparison calculation for the basket, and results corresponding to the baskets for the other store.

This application is a continuation of International Application PCT/US12/00426, filed on Oct. 3, 2012, and claims the benefit of U.S. Patent Application Ser. Nos. 61/542,519 filed Oct. 3, 2011 and 61/542,527 filed Oct. 3, 2011, the disclosures of which all are incorporated herein by reference in their entireties.

### FIELD

This disclosure relates to methods and systems for automating and streamlining consumer shopping purchases.

### BACKGROUND

Buyers of consumer or business products are faced with a dizzying amount of data as they make purchase choices. Of increasing interest for shoppers is the desire to instantly and on the fly access and analyze all available data and have a system assist in recommending the optimal product and purchase decision based on criteria established by the shopper. (Ref. Wall Street Journal, “In-Store Sales Begin at Home,” Byron, Ellen, Apr. 25, 2011). Often products may have a wide variety of performance characteristics related to specific design differences that relate to how the product will—or will not—meet a shoppers needs and intended usage. For example a computer seller will often list a variety of characteristics including screen size, processor type, manufacturer and internal clock speed, operating system, memory quantity, hard drive size, graphics card and graphics card memory, weight and price. To purchase a computer, the shopper must decide amongst hundreds of potential combinations of very technical information and trade these design elements off against price and need. It may not be clear what design characteristics are appropriate for a given shoppers intended use. A young student might need the computer primarily for word processing while a college age student might use the computer for playing video games, watching movies and using technical simulation software and analytic tools like LabVIEW.

Helping a potentially non-technical (uninitiated, naïve, or novice) shopper self-define their needs and then map these needs to technical product features and capabilities to establish preferences and preference-price tradeoffs and recommendations is a challenging problem.

Shoppers have preferences when it comes to certain products and brands. In some cases these preferences will include a group of acceptable brands that the shopper views as interchangeable—or in economics terms “substitutes”. For substitutes, the shopper switches from one item to the other based on which one is available or which one has the lowest price—as they would be equally happy purchasing either product. Preferences are determined by the shopper based on a multitude of criteria depending on the category, industry—price, total cost, feedback from friends, professional reviews, warranty levels, and personal opinion.

Typically, a shopper will analyze some of the available data to make a decision, but rarely do they have the time or ability to analyze all data to make an optimal decision. They may compare products on a store shelf, look at coupons and store circulars, they may request multiple quotes, or they may ask their friends, sales persons or read expert reviews. But few have the time or ability to utilize all these options. As noted above, in some cases the shopper may not be qualified to understand or appreciate the product features critical to making a good purchase.

Determining whether a given purchase has been optimized is extremely challenging and time consuming for shoppers.

As an example, consumers or shoppers buy a variety of fresh and pre-packaged products to provide the food, cleaning, personal care and other needs of their families. Of increasing interest for shoppers is the desire to save money when buying these products and brands that they and their family members want.

Shoppers have preferences when it comes to certain products and brands. In some cases these preferences will include a group of acceptable brands that the shopper views as interchangeable—or in economics terms “substitutes”.

Typically, a shopper will visit one or more retail stores to meet their family's needs including traditional supermarkets, “dollar stores”, grocery stores, mass merchandisers, convenience or “C” stores, drugstores or so-called hybrid formats (e.g., Supercenters). shoppers may have a preferred retail store or may shop at multiple stores that the shopper views as substitutable. shoppers decide which store to shop at for a variety of reasons including: physical location or distance from the shopper's home, perceived or real price differential versus competitive retailers, specific item specials or store-level promotions, cleanliness, friendliness of personnel, service, produce freshness, deli selection, meat quality or selection and positioning (e.g., “organic” or “natural” etc.).

Shoppers may choose a retail outlet based on their perception of the overall “value” provided. “Value” being a combination of “price” and other decision criteria.

Determining whether a given Retail store has the lowest price is extremely challenging and time consuming, if not impossible, for shoppers.

Beyond retailer pricing strategy and mark-up approach, collecting and evaluating the information necessary to make an informed decision on an individual item and total grocery basket is extremely daunting. A typical Retail store has over 38,718 items (Food Marketing Institute (FMI), 2010, see: http://www.fmi.org/facts_figs/?fuseaction=superfact) spread out over 46,000 sq. ft. (FMI, 2010). For any given item on a grocery list there are multiple acceptable brands, multiple jar/can/box sizes, multiple flavors, multiple pack sizes—each with its own shelf price and promotional programs. Free-standing coupon inserts or “FSI's” provide the majority of coupon activity and total 291 billion coupons annually (KantarMedia.com, 2010, FSIs only)—or approximately 100 coupons per week per household. Another 41 billion coupons are delivered via direct mail and other in-store and on package means. In addition, multiple retailers deliver weekly circulars to shoppers in a market area that include 200-400 additional item level discounts and promotions. Retailers also provide pricing discounts and incentives via loyalty or frequent shopper cards. In-store, manufacturer sponsored temporary price reductions (TPRs) are tagged on-shelf where additional coupon machines may be present. Finally, once the shopper has purchased their groceries there are more coupons (17.3 billion in 2010) that are delivered after checkout that are triggered by the items purchased, such as Catalina Marketing coupons.

For brand Marketers or manufacturers and retailers huge amounts of effort and money are wasted on trying to reach and influence shoppers to purchase a particular item or shop at a particular store.

It is estimated that brand Marketers spent $19.1 billion to deliver and redeem 332 billion coupons to shoppers in 2010. $15.1 billion was on “insertion” or the cost to actually deliver the coupon with only $4 billion providing actual savings for shoppers. The vast majority of these coupons, (86% in 2009, Source: 1997-2001, Watts NCH Promotional Services, http://www.santella.com/coupon.htm#GS1 DataBar™ COUPON BARCODE MAKES ITS DEBUT; 2008, CPG Coupons, Santella Coupon Trends-2011) were FSI coupons delivered via newspapers. FSIs delivered via newspapers represent a vanishing breed. Research indicates that only 34% of households read the news in newspaper in 2010 (Pew Research Center, 2010). Other studies indicate that Sunday papers (in which FSIs are inserted) reach only 13.5% of Americans versus nearly 30% in 1945. Much of the decline has been attributed to a shift into on-line media vehicles where FSIs are not a factor.

### SUMMARY

In some embodiments, a method comprises:

(a) receiving from a mobile device (MD) a first list identifying at least one item and a store list identifying at least one store; wherein the items of the first list range in specificity from at least a category level descriptor to a specific stock keeping unit (SKU), wherein the respective first list of items at each of the at least one store represents a respective basket;

(b) for each of the at least one store, performing in a computer remote from the MD at least one comparison calculation among the baskets, the comparison calculation being performed at the category level or a lower level, identifying a combination of SKU's, corresponding to the items in the basket, that best satisfies the comparison calculation for each basket;

(c) after step (b), receiving from at least one computer implemented direct marketing campaign management system, at least one additional retail incentive offer; and

(d) after step (c), transmitting to the MD an identification of a recommended store, the recommendation comprised of one of the at least one store, and a second list containing a set of respective SKU level item descriptors that best satisfy the comparison calculation for the basket, and results of the comparison calculation corresponding to the other Baskets for the other at least one store.

In some embodiments, a method comprises:

receiving from a user at least one string descriptor entered via a keyboard of a device,

searching using the string descriptor amongst a database of items, said database of items comprised of items available for sale in at least one store pre-selected by the user, said database of items categorized using a series of descriptive classifications, said classifications defining levels, wherein each level has a respective plurality of sub-set descriptors, wherein the sub-set descriptors of one of the levels are mutually exclusive;

matching the string descriptor against the series of classifications describing the items in the database and the sub-set descriptors by matching from the highest level of classification to the lowest level of classification for a match to the at least one string descriptor;

transmitting, for display on the device, the sub-set descriptors of the highest one of the classifications that matches the at least one string descriptor;

receiving from the device a signal indicating that the user has selected one of the displayed sub-set descriptors;

transmitting signals to cause the device to display, for user selection, the next lower level including its respective sub-set descriptors for the classification associated with the selected one of the displayed sub-set descriptors; and

repeating steps (e) and (f) until the sub-set descriptors associated with a respective classification at each of the levels have been displayed or a sub-set selected corresponding to a specific SKU,

In some embodiments, a system comprises:

a programmed processor and at least one database accessible by the programmed processor;

the programmed processor configured to communicate with a mobile device (MD), the MD configured with a shopper module that provides an interface to be used by a user for creating a shopping list to facilitate shopping in a retail store; and

the programmed processor configured to communicate with at least one direct marketing campaign management system, wherein the programmed processor is configured to receive promotional offers and advertisements for transmission to the MD while the shopper module is running, for presentation to the user on the MD.

### BRIEF DESCRIPTION OF THE DRAWINGS

FIG. 1 is a block diagram of a personal sales agent system.

FIG. 2 is a block diagram of the retailer component of the system of FIG. 1.

FIG. 3 is a block diagram of the product manufacturer marketer component of the system of FIG. 1

FIG. 4 is a diagram of the shopper databases of the system of FIG. 1.

FIG. 5 is a diagram of additional data sources used by the system of FIG. 1.

FIGS. 6A and 6B are a flow chart of the method of recommending an optimally priced list of products for a shopper.

FIG. 7 is a block diagram showing the four main components of the system.

FIG. 8 is a flow chart of a method for computing the lowest cost for the one or more items.

FIGS. 9A and 9B are flow charts of the method performed by the shopper in a bricks-and-mortar store (FIG. 9A) and an e-store (FIG. 9B).

FIG. 10 is a table showing a computation of the dead net price by the system of FIG. 1.

FIG. 11 is a block diagram of an embodiment of the system of FIG. 1 adapted for grocery stores.

FIG. 12 is a block diagram of the retailer component of the system of FIG. 11.

FIG. 13 is a block diagram of the product manufacturer marketer component of the system of FIG. 11.

FIG. 14 is a block diagram of the shopper preference database.

FIG. 15 is a flow chart of a method for computing the lowest cost for the one or more items.

FIG. 16 is a flow chart of the method performed by the shopper in a grocery store.

FIGS. 17A-and 17B show an example of a user interface display for developing the shopping list by traversing through different levels in the products database.

FIG. 17C shows an output displayed when the system has found a least cost store and basket.

FIG. 17D is a display of the mobile device after accepting the recommended store and list and indicating that shopper is about to go shopping where the coupons is printed and carried to the store on the shopping trip.

FIGS. 18A and 18B are messages displayed to the user upon checking in at a store other than the recommended store (FIG. 18A), or at the recommended store (FIG. 18B.)

FIG. 18C shows the display of a special offer to the user by way of the mobile device.

FIG. 18D is a display of a reminder to the user to enter a loyalty card number.

FIGS. 19A and 19B show the mobile device displaying the shopping list sorted by aisle (FIG. 19A) or sorted by category (FIG. 19B).

FIG. 20 shows a screen displayed to the user for manual check-in at the store.

FIG. 21 shows an interface to permit the user to share information about good values with other users.

FIG. 22 shows a screen displayed to remind the shopper that one or more items have not been picked up when the user initiates checkout.

FIG. 23 shows a display of a bar code and frequent shopper number the shopper can use to scan in her store loyalty card number or present at checkout.

FIG. 24 shows a display of the store selection component.

FIGS. 25A-25C show the interface used to select items for the shopping list at a sufficiently low level that the candidate space includes substitutable goods.

FIGS. 26A-26B show the display of a promotional offer to the user, and the system response to acceptance of the offer by the user.

FIGS. 27A-27E show the display interface for sorting, viewing and selecting the promotional offers.

FIGS. 28A and 28B are diagrams of prior art methods for direct distribution of circulars and coupons.

FIGS. 29A and 29B are block diagrams of a system for electronic delivery of e-circulars and e-coupons.

FIG. 30 is a block diagram of a web based campaign management system.

### DETAILED DESCRIPTION

This description of the exemplary embodiments is intended to be read in connection with the accompanying drawings, which are to be considered part of the entire written description.

For shoppers, the disclosed system will enable the preparation of a shopping list or the evaluation of specific or individual purchase choices using a web portal, tablet and/or smart phone application. The application recommends a list of items that best meet the shopper's requirements, based on price and relative performance—the “acceptable set”, calculates the overall list price automatically and recommends a specific retail location for the shopper to secure the lowest overall price or cost inclusive of available promotions and coupons for the item(s) selected. The application automates the way a shopper normally investigates and then makes purchase decisions thereby streamlining the purchase process.

For Retailers, the disclosed system will 1. Enable the Retailer to deliver marketing incentives based on conditional rules to a targeted shopper or shopper group that has decided to shop in the Retailers physical or online store, or another retail location, but has not yet made their purchase, thereby changing their retail location decision, 2. Enable the Retailer to deliver an e-circular that is targeted to the particular specials of an individual store and can also be targeted to a specific shopper or shopper group buying a specific item or list, and 3. Enable the delivery of targeted advertising via the shopper application at appropriate points during shopping preparation and execution. 4. Enable dynamic pricing for each customer, taking into account, e.g. customer profitability, price sensitivity, and other stores the customer is evaluating.

For brand Marketers, the disclosed system will 1. Enable the delivery of electronic or e-Coupons and incentives to the shopper, 2. Enable the insertion of other special incentives, based on conditional rules, that are delivered after a shopper has decided what to buy—but before the purchase has been made allowing for strategic and targeted incentives, 3. Enable the delivery of targeted advertising via the shopper application at appropriate points during shopping preparation and execution process, and 4. Enable dynamic pricing for each customer, taking into account e.g., customer profitability, price sensitivity, and other stores the customer is evaluating.

Both brand Marketers and Retailers will then have access to market intelligence based on actual pre and post buying behavior and preferences. Market segments based on consumer preferences and actions can be identified, promotion performance can be tracked, ROI by market segment can be calculated, and differences in performance across brands based on multiple variables can be ascertained. Previously, retailers and brand marketers needed to rely on inaccurate and expensive market research based on proclaimed intent by shoppers or aggregated sale data by region and had no accurate way to track actual behavior down to the shopper level.

Digital personal sales agents or “PSAs” are delivered via smartphones, tablets or other hand held devices and/or a computers and are herein used to analyze purchase choices and determine the optimal decision based on numerous factors including product performance and design criteria (eg. Amount of Random Access Memory (RAM) and computer processor clock speed in MHz)), price, total cost of ownership, usage requirements, quality, and peer/expert reviews and other feedback.

The system may access substantial data processing and database repositories and algorithms, to recommend to a buyer or Shopper the best choice for an individual or a group of chosen items based on pre-defined Shopper preferences and or complex product feature/performance and price trade-offs intended to maximize economic utility. The PSA aggregates all existing coupons and other financial discounts available on the item(s) of interest and recommends the best retail location (if applicable) to purchase the item(s) at the best price. As used herein, “retail” broadly covers any sellers dealing directly with consumers and end users, and includes both traditional retail, wholesale stores or warehouses as well as newer “e-retailers and other web-based retailers (e.g., Amazon.com, Zappos.com, Dell.com).

In addition to streamlining the preparation, selection and shopping process for shoppers the system allows retailers and brand marketers or manufacturers the opportunity to influence shopper choice just prior to actual purchase by providing targeted incentives based on the immediately planned purchase and/or shopping trip, shopper preferences, demographics, geographic or competitive inputs and other variables derived from the “smart” predictive systems and models contemplated.

The PSA also optimizes decision making on ancillary purchase decisions such as extended warranties, leasing/buying, financing options, etc.

Industries of relevance include but are not limited to:

Grocery/Supermarket

Home goods

Hardware

Automotive parts

Automobile

Boating/RVs

Beverage

Leasing/Financing

Electronics

Toys

Video games/music/video/books

Furniture

Household appliances

Jewelry

Mattresses

Musical instruments

Pet products

Power tools/lawn/garden

Hardware

Sporting goods

Lighting

Investments

Healthcare

Pharmaceuticals/Vitamins

Equipment rental

Telco hardware and services

Cable/satellite services

Apparel

Children's accessories

Baby items

Insurance

Personal products

Fine Wine and Champagne

Beer

Alcohol

Gourmet chocolate

Gourmet coffee

The system comprises hardware, software, databases and servers, processors and communication networks both wired and wireless that provides a robust, extremely fast and highly reliable experience for target customers including consumers or Shoppers, Retailer marketing or staff personnel and brand Marketers/staff personnel and researchers and other professionals. An embodiment comprises four inter-linked technology platforms targeting Shoppers, Retailers and brand Marketers. For shoppers the system will enable the preparation of a shopping list or the evaluation of purchase choice(s) using a web portal or smart phone application. The system includes a multi-level analytic system that elicits from the shopper how they intend to use a product and what specific performance variables are most important to the Shopper to establish purchase interest or utility for a given product offering. The system recommends a sorted/prioritized list of items that best meet the shopper's requirements (Highest purchase interest or utility), the “acceptable set”, calculate the overall dead-net price automatically and recommend a specific retail location for the shopper to achieve the lowest overall price or cost inclusive of available promotions and coupons for the items selected.

The application in essence automates the way a shopper normally researchers and then makes purchase decisions thereby streamlining the purchase process. In addition, the application functions as a Personal Sales Agent, or PSA, helping guide the Shopper in self-categorizing their intended product usage profile so that the system can establish appropriate preferences to aid in the down-selection of many feature rich and technical products into the “best” list of products that meet the Shopper's intended use. The system enables both retailers and brand marketers, herein “marketers” to deliver marketing incentives of various kinds including additional price-related incentives, directly to the Shopper during the preparation and execution of their purchase process. These incentives are included into the net purchase price and could be targeted by Retailers and Marketers based on a broad number of Shopper characteristics, preferences, behaviors, purchase history and the like. The System further provides post and pre purchase analytics to help Marketers and Retails evaluate their promotional efforts, better understand the Shopper and profitably grow their respective businesses or increase Shopper satisfaction and loyalty.

This system can influence Shoppers after they have indicated what they intend to purchase—but before the actual purchase has been made—in a streamlined highly functional application.

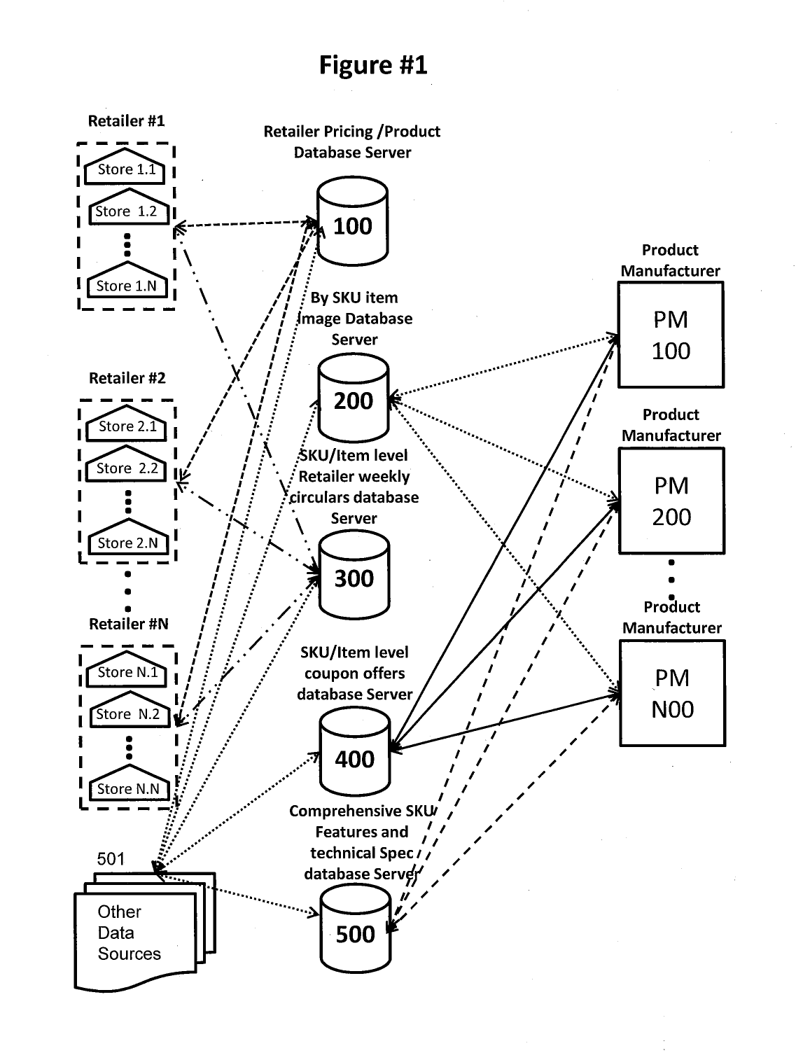

FIGS. 1-10 summarize the general method. FIG. 1 is a block diagram of an exemplary system. In some embodiments, at least one database server provides access to the system databases, including retailer pricing/product database server 100, SKU item image database server 200, SKU/Item level retailer weekly circulars database server 300, SKU/Item level coupon offers database server 400 and comprehensive SKU Features and technical specification database server 500. Data may also be received from other external data sources 501, such as manual data entry, automated web capture, web crawlers, secret shoppers or the like. The retailer pricing/product database server 100 includes: by-store, pricing zone, and individual item data for SKU #, Pricing, Brand/Mfg., List Price, Promoted Price, Description, and optionally other data. A plurality of retailers 1 . . . , N access the databases 100 and 300, and a plurality of product manufactures 100, 200, . . . , N00 access databases 200, 400 and 500. The data transmissions between the various servers and various non-transitory computer readable storage medium may be via internet, wireless or other electronic or physical means.

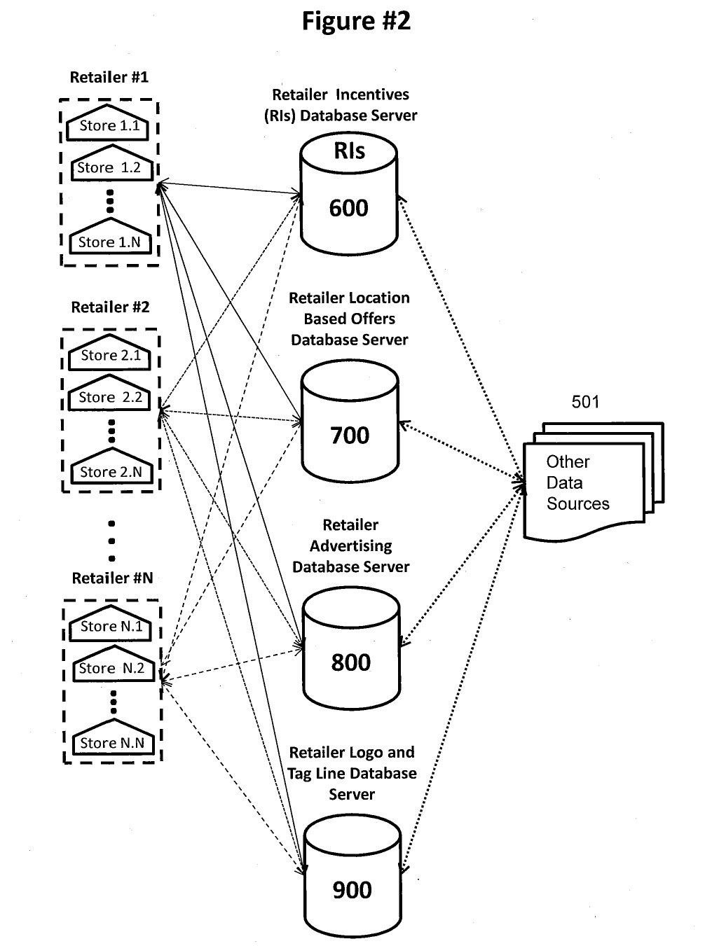

FIG. 2 shows an example of the retailers in communication with retailer incentives database server 600, other external data sources 501 (shown in FIG. 1), such as manual data entry, automated web capture, or the like. retailer location based offers database server 700, retailer advertising database server 800, and retailer logo and tag line database server 900 (which may be hosted in the same computer or a different computer from the servers of FIG. 1. The server 600 contains conditional Retailer Promotional offers (Rls) insertion rules, to offer values, items for etc. offered to Shopper by Retailer within Basket Cost Minimization Algorithm impacting the Initial Lowest Cost (ILC) list or basket. Server 700 includes Marketing incentives presented to Shoppers when they enter or select a specific retailer for item purchase—similar to in-store “wall of values” or in-store circular offers. Server 800 includes video, and still ads for display within Shopper smartphone and internet portal applications. Server 900 includes Retailer logo and tag line files for insertion into Shopper smartphone application and Internet portal applications. Logo and tag lines are also available to Retailer and Marketer portal applications.

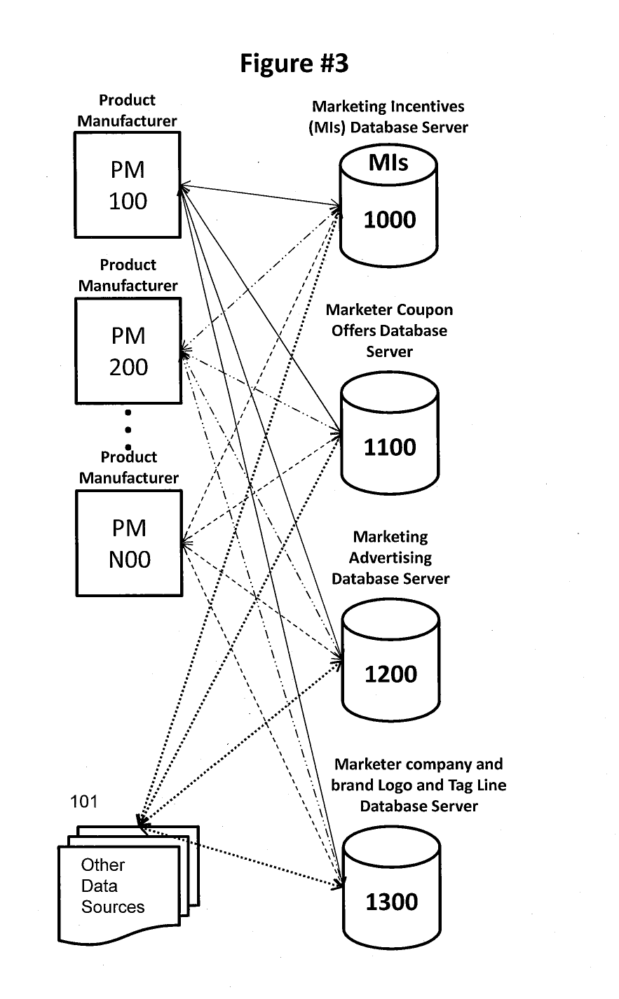

FIG. 3 is a block diagram of an example of the product manufacturer interface. The product manufacturers 100, 200, N00 communication with marketing incentives database server 1000, marketer coupon offers database server 1100, marketing advertising database server 1200, and marketer company and brand logo and tag line database server 1300. Data may also be received from other external data sources 101, such as manual data entry, screen scraping, or the like. Server 1000 provides conditional Promotional offers, insertion rules, offer values, items or the like offered to Shopper by Marketer within Value maximization/Price Minimization function impacting the Final Lowest Cost (FLC) for item (s). Server 1100 provides coupon incentives delivered online or other off-line efforts for use in calculating Initial Lowest Cost (ILC) list or basket. Coupon incentives are delivered within Shopper smart phone and internet portal for use in calculating Initial Lowest Cost (ILC) for item (s) or basket. Server 1200 Includes Marketer video, and still ads for display within Shopper smart phone and internet portal applications. Server 1300 includes Marketer company logo, brand logo, tag line files for insertion into Shopper smart phone application and Internet portal applications. The Logo and tag lines also available to Retailer and Marketer portal applications.

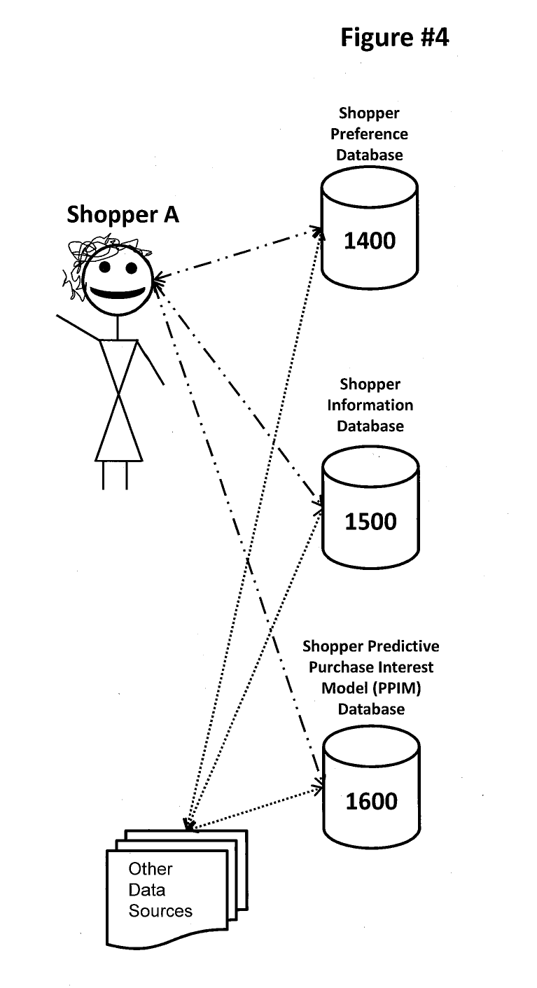

FIG. 4 show an example of the shopper preference databases 1400, shopper information database 1500 and shopper predictive purchase interest model (PPIM) database 1600. Database 1400 includes information such as Location/Home Store; Other Favorite Stores—Store substitutes; Decision rules—How Shopper wants price minimization algorithm to perform relative to substitutes (e.g., lowest comparable price, price differential to choose brand substitutes, lowest price override etc.); Preferred brand(s) by category; Suitable substitutes by category (other brand, private label etc.). and Shopper ID code. In one non-limiting example, the database 1500 includes name, address, log-in name and ID, demographic information, psychographic and behavioral information, item purchase history; basket/ring purchase history; promotion response history; preferences information; pricing differential response history; store preference history. In other embodiments, other data and/or combinations of data are included. Database 1600 includes Shopper ID code; Shopper basic category needs & usage (BCNU) prompt classification question responses (e.g., for determining the shopper's presets); Shopper Predictive Purchase Interest Model (PPIM) results from feature set prompt and feature driver weights; Shopper PPIM self-weighting inputs; Refined PPIM feature driver weights based on actual purchase. In some embodiments, the system uses learning for refining the PPIM feature driver weights.

In one embodiment the shopper preferences of the shopper database of product substitutes (SdBP) are initially set based on presets that are designed to represent different product preferences relating to various shopper affinity, demographic or psychographics. In one preset embodiment preferences are set for large families favoring larger sizes. In one preset embodiment preferences are initially set to include a greater representation of premium and so-called super premium products. In one preset embodiment initial preference presets are set to include those products more appropriate to smaller households. Other preset embodiment can be developed for various groups including older shoppers, “foodies”, “scratch cookers,” “aggressive savings focused” etc.

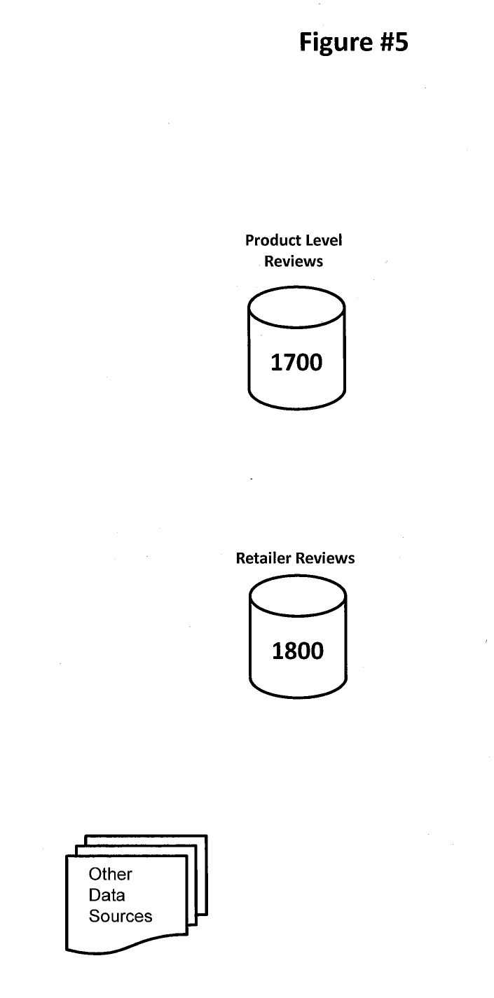

FIG. 5 shows an example of additional databases accessed by the system as secondary sources. Product level reviews database includes a database of product reviews from Shoppers and a Database of product reviews from industry experts and other expert reviewers. Retailer reviews database 1800 includes Database of Retailer reviews by Shoppers, and Database of other Retailer information (# of complaints, # of units sold etc.). These databases may receive data from public sources available on the Internet, and/or proprietary sources, such as the registration information collected by the system, and information exchanges with partner systems, web sites, loyalty programs, manually input data, screen scraping, and the like.

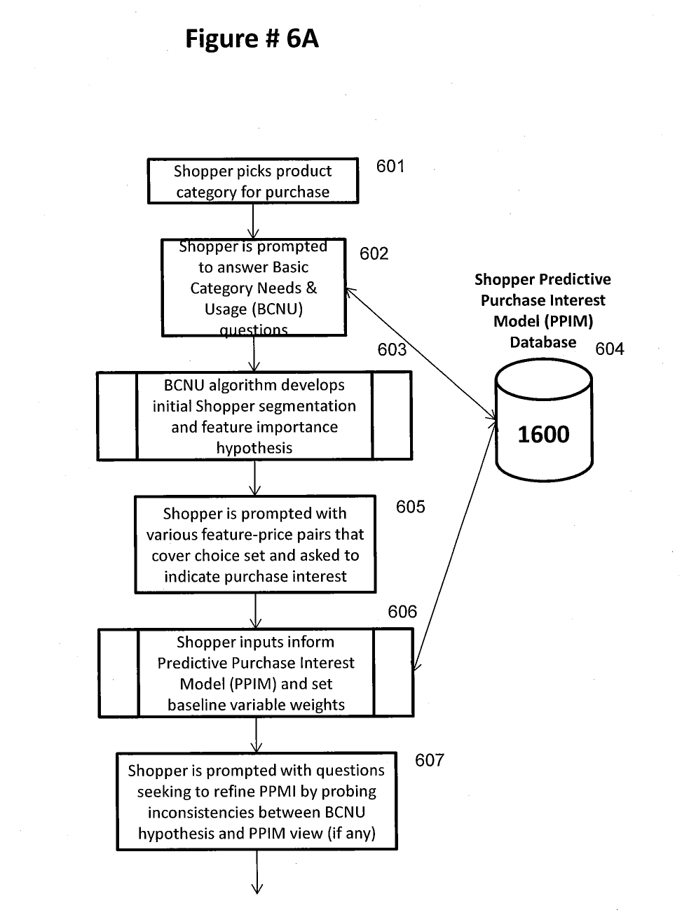

FIGS. 6A and 6B are flow charts of an example of how Buyer value/preference information can be determined to streamline and automate purchase selection and decision process in complex goods. Referring first to FIG. 6A, at step 601, the shopper picks a product category for purchase. At step 602, the shopper is prompted to answer by basic category needs and usage (BCNU) questions. The results are stored in the shopper predictive purchase interest model (PPIM) database 604, At step 603, the BCNU algorithm develops the initial shopper segmentation and feature importance hypothesis. At step 605, the shopper is prompted with various feature-price pairs that cover choice set and is asked to indicate purchase interest At step 606, Shopper inputs information form the Predictive Purchase Interest Model (PPIM) and sets baseline variable weights. These results are stored in the data base 1600. At step 607, the shopper is prompted with questions seeking to refine PPIM by probing inconsistencies between BCNU hypothesis and PPIM view (if any). Referring now to FIG. 6B, at step 608 the PPIM is applied to all product/feature options to calculate “fit” or purchase interest score. At step 609, the shopper is presented with product choices with the highest PPIM score and, in some embodiments, additional subjective information. (e.g., reviews).

At step 610, the Shopper uses Purchase interest sliders to refine recommended product set. At step 611, the shopper selects a product. At step 612, the system incorporates RIs and presents Shopper with Retailer Recommendation and MIs. At step 613, Shopper makes purchase electronically or at Retail location. The results of the actual purchase are compared to the PPIM 1600.

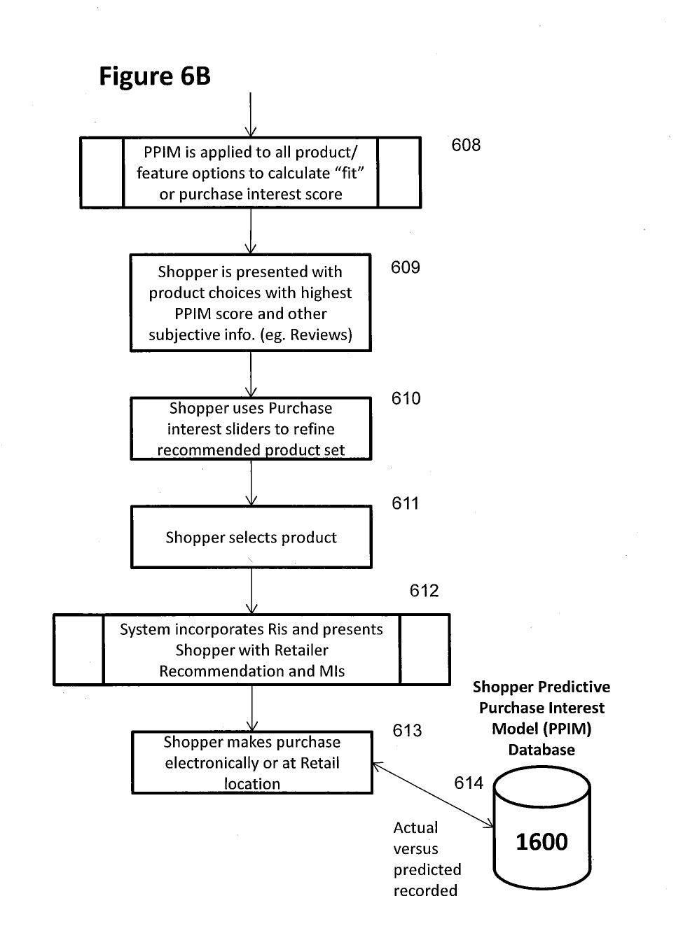

FIG. 7 is a block diagram of an example of a system 701. A shopper application 702 receives inputs from the user (shopper) and displays results. A retailer web portal campaign management display and input system provides the interface to retailers. A marketer web portal campaign management display and input system 704 provides the market interface. Analytics/research web portal display and input system 705 provides tools for the retailers and marketers. The databases used by the system include the product database including products/SKU-level information 100, 200, 300, 400, 500. The retailers provide Retailer and Marketer Incentives, Ads and Other Information 600, 700, 800, 900, 1000, 1100, 1200, 1300. The analytic cost minimization module 701 receives all of the above inputs and determines Shopper Characteristics 1400, basic Category Needs & Usage (BCNU) 1500 Predictive Purchase Interest Model (PPIM) 1600 and Product Reviews 1700.

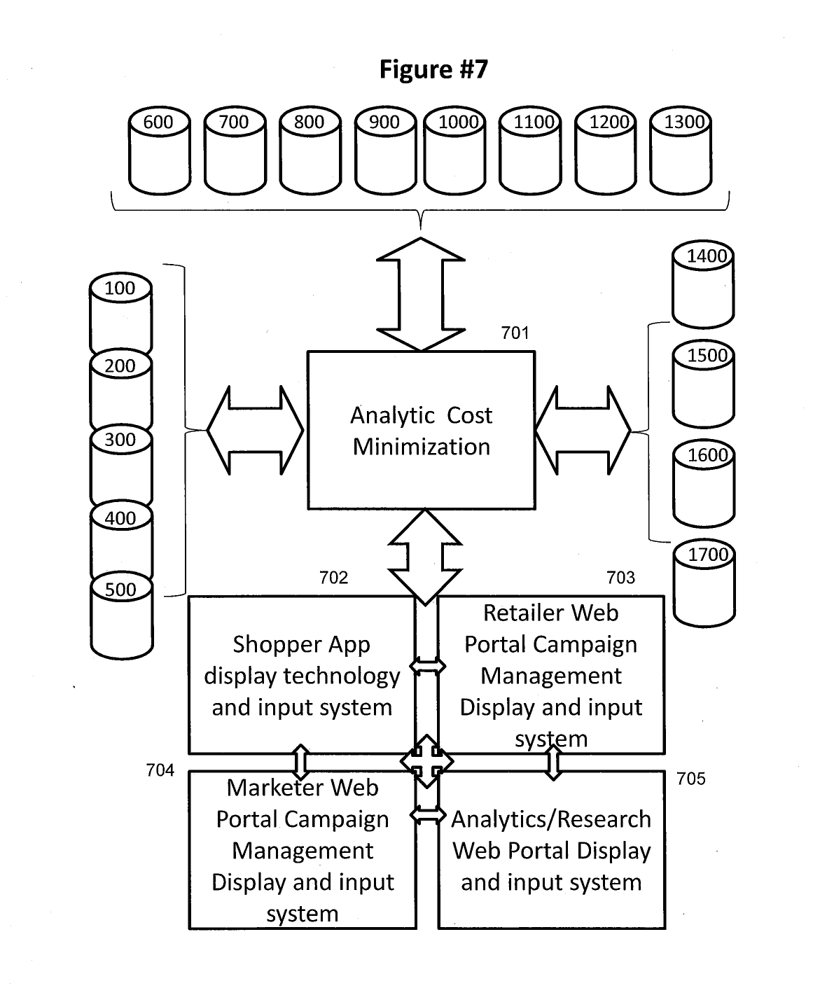

FIG. 8 is a flow chart for the method of Making a List and Identifying what and where to buy item spending the minimum amount within defined Shopper preferences. At step 800, the shopper logs on to the website or starts a streamlined version of the shopper app on the mobile device. At step 802, the shopper selects a category of interest (e.g., cameras). At step 804, the shopper responds to Questions to inform BCNU and Predictive Purchase Interest Model (PPIM). At step 806, the PPIM recommends a product list. At step 808 and 810, the system issues one or more non-on-list (NOL) coupon offers for consideration. At step 812, the shopper selects “Done” ending list creation and initiating cost minimization algorithm. At step 814, the Minimization Algorithm Calculates DNP for each product recommended by PPIM at all alternate e-Retail/Retail locations. At step 816, the minimization function Identifies “Initial Lowest Cost” (ILC) item and basket option and Retail location providing. At step 818, a determination is made whether there are any retailer incentives (RIs). If so, step 820 is performed. If not step 822 is performed. At step 820 the Minimization Algorithm incorporates RI's and recalculates basket cost, now the “Subsequent Lowest Cost” basket and Retail Location providing. At step 822, if there are no RIs, the ILC becomes the SLC. At step 824, SLC is displayed to Shopper along with MIs. At step 826, a determination is made whether there are any marketing incentives (MIs). If so, step 830 is performed. If not step 828 is performed. At step 830, the Minimization Algorithm recalculates basket or item cost including all MI's—final SLC becomes “Final Lowest Cost (FLC) item(s) or list. At step 828 the SLC becomes the FLC. At step 832, the Lowest cost for item and Retail store (FLC) presented to Shopper for shopping trip/e-purchase.

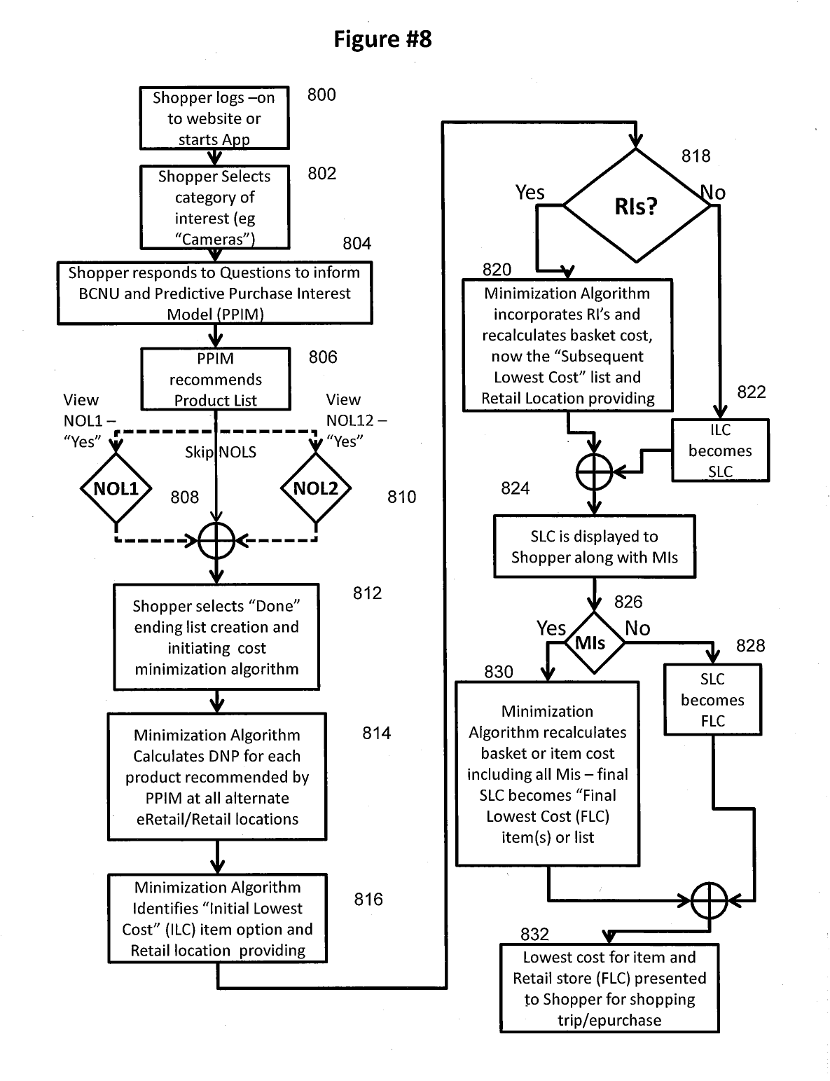

FIG. 9A is a flow chart showing Retail store, and FIG. 9B shows the corresponding flow for an eRetail store, The shopper uses FLC list to shop for item(s) in streamlined fashion. In FIG. 9A, at step 902, the shopper takes the shopping list to the retail store on the smart phone or other mobile device. At step 904, as Shopper enters store, Shopper is presented with a splash page of “In-Store Incentives” (ISIs) or Ad. At step 906, a determination is made whether ISI is accepted. If so, step 908 is performed, and the selected Items (if any) added to list and basket total. At step 910, the shopper picks up items on the list. At step 912, the shopper checks out, (optionally scanning his/her smart phone or other mobile device) to record and validate purchases, redeem e-coupons and create valid redemption record for coupon fulfillment In some embodiments, coupons and other promotional offers are validated and fulfilled by the displaying of a scanner bar, shopper number, frequent shopper card, radio signals, WIFI signal, blue tooth signal, near field communication, LED modulated light interacting with the scanner system or other electromagnetic, sound, visual means or other methods.

In FIG. 9B, at step 914, the Shopper goes to eRetailer and enters tracking code. At step 916, the Shopper is presented with a splash page of additional incentives, if any (ISIs) or Ad. At step 920, the selected Items (if any) added to list and basket total. At step 922, the shopper proceeds to checkout. At step 924, shopper checks out, entering tracking code to receive any additional incentives, ecoupons and records the purchase.

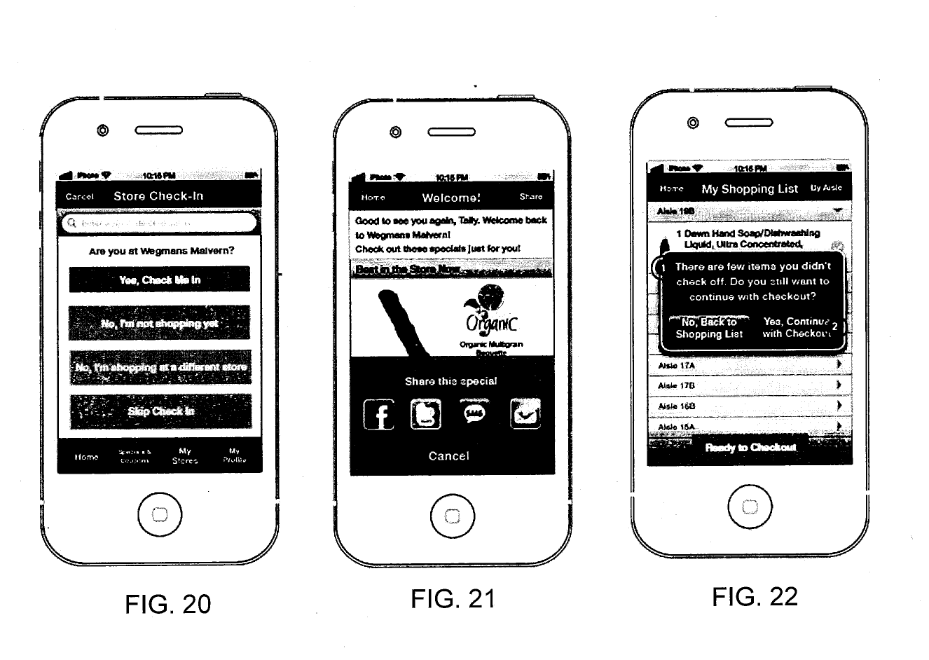

In some embodiments, when the user initiates checkout, the mobile device determines whether all of the items on that list have been checked off. FIG. 22 shows a warning issued if there is one or more item on the list that has not been checked off, and asking if the shopper wants to return to the list and continue shopping.

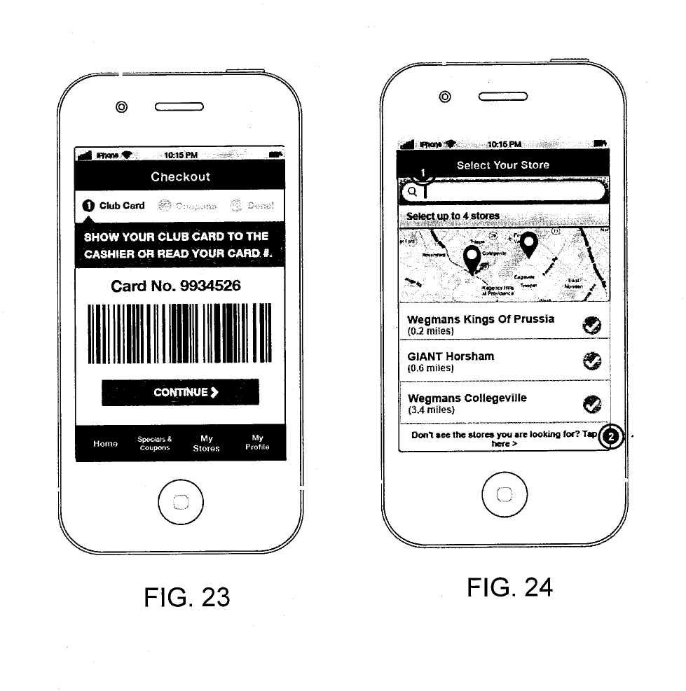

In some embodiments, when the user is finally ready to check out, the mobile device displays a bar code and number representing the customer's loyalty card number to be scanned or read in by the cashier, as shown in FIG. 23. The Shopper may use device-to-device communication methods other than barcode as enabled by system including: Bluetooth or cellular (eg CDMA) wireless transmission, near field communication, LED, modulated light, audio (sound wave) or other means.

The first component platform, herein the “Shopper App,” is web portal and Smartphone application for consumers or herein “Shoppers” that:

Allows Shoppers to enter a specific product category of interest (eg. “Cameras”) forming the initial starting point for determining how a Shopper intends to use the item and what is important to the Shopper for establishing which specific products to research.

Enables the prompting of the Shopper via web or smartphone interface to answer a series of questions relating to the category and how the Shopper intends to use the product—herein called “Basic Category Needs & Usage” (BCNU) questions. BCNU questions may form an initial segmentation hypothesis for how Shopper will use product and what products are relevant to the Shopper.

Optionally presents the shopper with a series of product feature/price combinations to understand how Shopper assigns value or purchase interest to different products. Answers to prompts will be used to create a Predictive Purchase Interest Model (PPIM) that can be used to evaluate any combination of product feature and price and will provide a estimate of whether new product meets Shopper needs (and how well). PPIM categorizes the shopper into a buyer group or market segment and link this segment to a set of products

Optionally prompts the shopper with questions to further develop the PPIM based on and found discrepancies/anomalies between the predicted market segments and products and the BCNU responses.

Uses the shopper's responses to the questions to refine the PPIM model or actual behavior.

Presents the shopper with a list of 1-10,000 product/feature and price options. Product options are ranked by the over “Fit” or purchase interest as determined within the PPIM model. The product list includes links to peer and professional reviews, review key-word search database and other subjective or related information (reliability data).

In some embodiments, using a web inerface, presents “slider” controls on key predicative product features for Shopper to make adjustments to values, impacting recommendation list; Recalculates value and re-presents when sliders were changed. Showing original rank next to items. Final slider settings are recorded in system for post purchase validation.

Calculates for the shopper a lowest cost for the item or list of items so as to minimize the individual item and total basket cost within shopper defined or presets or initial setting preference parameters taking into account all available or “live” price discount mechanisms of any kind stored in system database. This list initial recommendation is herein called the “Initial Lowest Cost” list (ILC).

Allows for Retailer Incentives (RIs) to alter the recommended retail store outcome presented when the ILC is calculated for the shopper by the inclusion of a post-ILC incentive that further reduces the basket cost and shifts the cost minimization “win” from one Retailer to another as presented to the shopper in a final list/recommendation. This list is herein called the Subsequent Lowest Cost List (SLC). If no retailer incentives are active the SLC and ILC are identical and the shopper is presented with the ILC. Otherwise, if a RI changes the minimization outcome, the shopper sees the SLC list only.

Displays recommend list of items for the shopper that includes a “check box” icon or other similar graphic device or icon for different choices.

Allows the shopper to choose a recommended product option and then displays additional Manufacturer Incentives (MIs) that may be available. As used herein, MI's are any form of promotional offer that is displayed to the shopper along with the final lowest cost (FLC) list. MI's can be planned and inserted into the shopper app by at least one web-based campaign management system. MI's can be inserted by marketers, retailers, ad agencies or interested third parties.

Displays MIs that may be accepted by shopper and addition of other items or more units or larger size or the like, which result in: the replacement of item in shopping basket that was immediately adjacent to icon, recalculation of basket cost and inclusion of additional incentives relevant to item and basket costing and item cost.

After MIs are reviewed and selected a new final recommendation and basket cost will be calculated with a total cost for the basket and savings versus the next retail option displayed. Once all MIs are considered or no more are selected the list will be a final list. This list is herein called the Final Lowest Cost list (FLC), In some embodiments, the Shopper can then select an option or trigger that orders that basket list for more rapid product selection and purchase at the recommended store. In some embodiments, the list is ordered by item category. In some embodiments, the list is organized by location in the store. In some embodiments, the list is organized by store department. In some embodiments, the list is organized by shelf position.

Once the shopper has completed shopping, and items can be purchased either at a physical retail outlet or at an eRetailer. The system will allow the shopper to use their smartphone application to present a scan-able bar code, blue-tooth signal or near field, Led signal, number communication (NFC) enabled signal to record the purchases and link electronic coupons, and shopper card incentives to the shoppers' identity, to reduce basket cost appropriately and provide purchase record for validation. Alternatively, the system will present the shopper with a purchase promotional code that will verify shopper identity, trigger incorporation of various shopper discounts and incentives (RIs and MIs) and record purchase in shopper information database and PPIM validation system.

The shopper App captures servers and databases, consumer demographic information, purchase information, preferences and decision rules and other information relating to purchase behavior.

The shopper App and supporting systems is compatible with iPhone (Apple OS), Android (Android OS), Blackberry devices (RIMOS), Microsoft OS and other suitable smartphone or mobile device operating systems, tablets and other mobile devices.

Allows the shopper to share a shopping list and final purchase price with social networking peers.

| Action | How it works | Technical requirements |
|---|---|---|
| 1. Shopper inputs | Web or Smartphone interface prompts the | Database of product specific |
| preference | Shopper with a series of category specific | information including |
| information | questions to determine what the key areas | specifications, features, |
| | of need or benefit are for a given Shopper | performance and pricing. |
| | and what the relative importance is for the | Mechanism for Shoppers to |
| | various performance drivers within the | input preferences in a Web |
| | product category. These questions form | or Smartphone format |
| | the “Category Needs & Usage (BCNU) | through a series of |
| | questions and help initial Shopper | intelligent prompts. |
| | Segmentation and product | Algorithms to tease out |
| | recommendations. BCNU prompts include | benefit/need prioritization, |
| | questions on intended usage, self- | feature driver importance |
| | categorization as “professional” or | and weight in purchase |
| | “amateur” and other relevant, category | decision. Algorithms to |
| | specific criteria. Eg. for computers; laptop | develop a predictive |
| | or desktop, student, professional, screen | purchase intent model for |
| | size, business or gaming, word processing | various product |
| | or graphics intensive etc. | feature/price option by key |
| | The Shopper responses are then used in an | Shopper segments and for |
| | algorithm to form an initial BCNU model | individual Shopper. |
| | that classifies the shopper into a shopper | |
| | segment linked to specific product | |
| | performance needs. | |
| | The shopper is then prompted with a series | |
| | of product feature-price options that | |
| | provide the analytical input to a Predictive | |
| | Purchase Interest Model (PPIM) that are | |
| | used to evaluate all category product | |
| | offerings and establish a “Fit” or relative | |
| | purchase interest value representing how | |
| | well a specific offering meets the Shopper's | |
| | needs. | |
| | The shopper is then prompted with a few | |
| | questions to resolve any discrepancies in | |
| | responses and predictions between the | |
| | BCNU and PPIM inputs. | |
| | In some embodiments, using a web | |
| | interface, the PPIM then presents from 1-10,000 | |
| | product options ranked on how well | |
| | they meet Shopper needs (or Fit) and Price. | |
| | Items are presented with links to peer and | |
| | professional reviews and other functional | |
| | characteristics | |
| | In some embodiments, the system allows | |
| | the shopper to control key purchase | |
| | interest drivers by a series of “slider” | |
| | controls post the PPIM first listing. PPIM | |
| | recalculates “fit” and redisplays a new list | |
| | after each slider change. The original fit | |
| | recommendations are maintained as | |
| | “Recommendation Rank” on display. | |
| 2. Shopper | The PSA evaluates a set of acceptable | Database of product specific |
| selects from an | purchase options based on preferences | information including |
| “acceptable | determined in step 1. | specifications, features, and |
| set” of items to | The acceptable set is rank ordered based | pricing. |
| establish final | on characteristics such as % of feature fit, | Database of product |
| shopping list | price, peer reviews, expert reviews, expert | evaluation information |
| | opinion, and total cost of ownership with | including market segment |
| | the goal of maximizing economic utility for | feature needs, expert |
| | the Shopper. The PPIM proprietary | reviews, peer reviews, and |
| | algorithm identifies the items to present in | reliability ratings. |
| | the list and the order of presentation. | PPIM algorithm matches |
| | Manufacturer advertising and offers are | specifications, features and |
| | presented in the context of the purchase | price to specific pre-defined |
| | decision. | groups of Shoppers (target |
| | <Note> Step 1 and Step 2 can be delivered | segments) |
| | as a technology capability that can be | Manufacture Advertising |
| | delivered as a private label service within | and Promotion Engine that |
| | an existing e-commerce site or physical | serves up pre-determined |
| | store location. | offers to specific target |
| | | Shoppers based on |
| | | demographics, purchase |
| | | history and purchase intent. |
| | | This could be a separate |
| | | embodiment - that is the |
| | | capability to intercede at |
| | | “checkout” on website so |
| | | that Marketers/ |
| | | manufacturers could |
| | | program a conditional offer |
| | | that try to switch the final |
| | | purchase decision from say |
| | | one Brand to another. |
| | | Likewise, we will offer |
| | | capability for eRetailers or |
| | | regular retailers to |
| | | intercede retail location |
| | | recommendation with |
| | | competitive offer that |
| | | changes “win” of retail |
| | | algorithm. |
| 3. Shopper | The PSA recommends the best venue to | Database of Retail |
| selects the | purchase the item(s) taking into account | information including item |
| location to | things like store preferences, retailer | level detail, list prices, |
| purchase the | reputation, financial strength, personal | promotional prices and |
| item(s) | purchase history, cost of travel, online | location. |
| | purchase acceptability, store loyalty | Database of past shopping |
| | program participation, and special offers | behavior that includes |
| | made by the Retailer. | stores shopped based on |
| | Alternative purchase venues may be | time of day and day of |
| | provided that optimize economic utility in | week, items selected, |
| | ways other than price - ie convenience, | departure location, and |
| | past behavior, store loyalty programs, etc. | store loyalty program |
| | Retail recommendation could be changed | participation. |
| | based on RIs (Retailer Incentives) | Retailer Advertising and |
| | | Promotion (RIs) Engine that |
| | | serves up pre-determined |
| | | offers to specific target |
| | | Shoppers based on |
| | | purchase intent, purchase |
| | | history, and demographic |
| | | information as they are |
| | | making their decision |
| | | regarding which store to |
| | | shop at. |
| 4. Shopper is | The PSA presents the optimal location for | Algorithm analyzes prices |
| presented with | purchase, and the final price net of all | and promotions offered by |
| the total “dead | special offers and incentives. | retail location and |
| net” cost to | | recommends the optimum |
| purchase | | location for purchase based |
| selected items | | on price, retail store and |
| at the | | product preference and |
| recommended | | previous shopping patterns. |
| retail location | | The system will learn over |
| (virtual or | | time and optimize |
| physical) | | recommendations based on |
| | | actual Shopper buying |
| | | patterns. |
| 5. Shopper is | Once the Shopper enters a store the store | Geo Targeted Promotion |
| offered | can offer promotions specifically targeted | Engine that serves up |
| additional | to that Shopper and presented on their | retailer offers to select |
| promotions | smartphone. | Shoppers based on the |
| once live in the | A similar offer can be made by an e- | Shoppers' demographics, |
| store or on the | commerce retailer once the Shopper visits | purchase intent, purchase |
| website | their business online. The offer can be | history, and current location |
| | presented via the Shopper's smartphone or | (both physical and virtual). |
| | directly on the website or once the cart is | MIs can also be presented |
| | displayed. | at this final pre-purchase |
| | | stage. |
| 6. Shopper scans | In a physical store, the Shopper will scan a | Database to collect |
| the PSA app at | barcode in the PSA app at checkout to | purchase history triggered |
| checkout to | activate and redeem all relevant coupons | by the Shopper scan at |
| redeem all | and special offers. Shopper may use other | checkout or the utilization |
| relevant | device to device communication methods | of a special code or tag in |
| coupons and | other than barcode as enabled by invention | an online purchase. This |
| special offers | including: Bluetooth or cellular (eg CDMA) | purchase history can be |
| | wireless transmission, near field | integrated and aggregated |
| | communication, LED, modulated light, | with store loyalty program |
| | audio (sound wave) or other means. | data. |
| | On an e-commerce site the Shopper will | Database of bar codes, |
| | utilize a special promotional code or tag | special codes or tags that |
| | provided by the manufacturer and/or | are assigned to Shoppers in |
| | retailer to redeem all relevant coupons and | the PSA to identify each |
| | special offers. | unique shopping experience |
| | | and transmit promotional |
| | | information at the point of |
| | | purchase. |

One detailed example of an embodiment is a system for automating and streamlining consumer grocery shopping purchase-decision process of product choice preference and lowest-price matching enabling targeted, immediately pre-purchase decision direct-marketing capability.

Some embodiments provide a system for delivering highly targeted and situation-ally relevant/aware promotional offers and advertising to a consumer shopping for groceries

A system is provided in which smart phones or other hand held mobile devices and/or a computer are used to develop a grocery shopping list and streamline the shopping price for shoppers. The system can access substantial data processing and database repositories, and calculate the lowest price for a group of chosen items both individually and together (“basket”) thereby recommending to the shopper the specific items and retail location to purchase them at that results in spending the least amount of money.

The lowest price, or “Dead-net Price” is the price for a given item that takes into account the manufacturers item cost to the retailer, customer margin or pricing strategy, manufacturer incentives (TPR or temporary price reductions), other manufacture incentives, coupons of all types and other retailer incentives, sales and promotions.

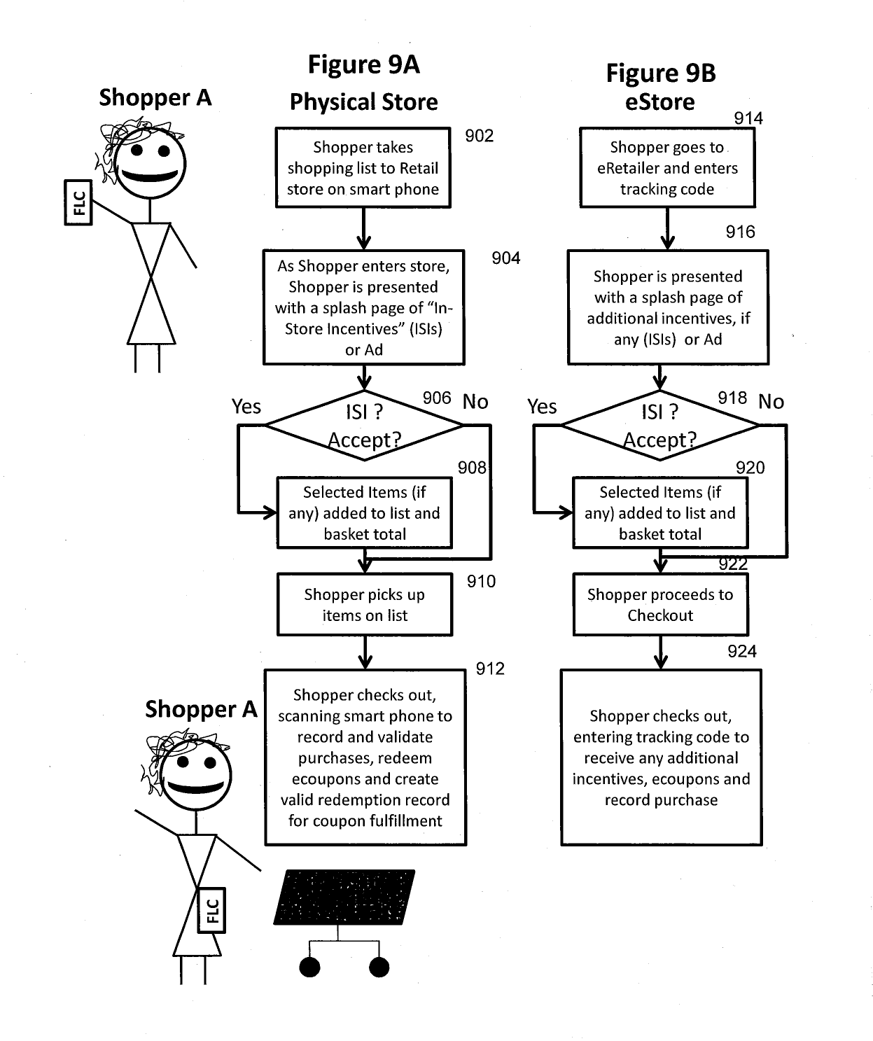

The lowest possible amount a shopper can pay for an item is herein called the “dead-net price”. See FIG. 10 for examples of dead net price. Consumer dead-net price is the lowest price available to consumers on a individual item when all active promotional programs are taken into account. The following definitions are used:

List Price—The price per unit charged by a manufacturer to a retailer, also known as “cost” to the retailer.

TPR—Temporary Price Reductions offered by Manufacturer,

MIP—Merchandising Incentive Program funds applied by manufactures,

FSI—Free standing coupon insert, coupons delivered in Sunday newspapers typically by manufacturers, Retail Circulars—Promotions run weekly by retailers on store items

Shopper Card—Other discounts delivered on shopper card or via in-store circular

Mark-up—the margin markup applied to a list price to calculate shelf-price. Retailers may divide List Price by (1-mark-up) to reach shelf price.

In FIG. 10, the TPR and MIP may or may not be reflected in price or passed on by the retailer to the consumer. The retailer markup may be negative for loss leaders, may vary by item, pricing zone, retailer strategy etc.—peculiar to chain, item and strategy. The retailer gross margin and margin may be negative, or higher or lower versus typical margin. They could also include payment discounts/terms and returns & allowances payments or adjustments.

For a given item, the dead-net price of that item represents the lowest price that would be charged to the shopper when all active marketing incentives or other price related incentives are taken into account along with the normal shelf price at a particular retailer. Even if all live marketing incentives are taken into account the price at one retailer may still be lower than another due to a lower mark-up (e.g., Every day low price (EDLP) strategy versus Hi-Low price strategy), more efficient operation, different cost of goods and other factors.

For example, the following prices were found in a single market for a single item, 24 oz Prego Spaghetti Sauce in a recent survey:

TABLE 1

| Store | Shelf Price | Sale Price |
|---|---|---|
| Store 1 | $1.79 | |
| Store 2 | $2.59 | $1.67 |
| Store 3 | $1.89 | |
| Store 4 | $2.39 | |
| Store 5 | $2.89 | |
| Store 6 - eRetailer | $3.50 | |

The shelf price differences noted above are based on retailer pricing strategy. Store #1 and Store #3 are two retailers pursuing an “EDLP” or “every day low price” pricing strategy. Store #2, 4 and 5 are all “HI/LO” or high-low pricing strategy customers. Store 6 is an e-retailer. HI/Lo customers set the shelf price high and then discount or place the product on sale to attract shoppers. Store #2 has just this kind of sale. Looking just at the shelf price—the shopper buying at Store 5 pays $1.10 MORE for the SAME product than if they had purchased the item at Store 1. While Store 6 has the highest price on this item, the shopper's overall basket may be lower, and a shopper's total list and by-item pricing are considered. Further as discussed below with respect to “cherry-picking”, in some embodiments, the user is given the option to request a lowest price basket to split between/among two or more stores, so other items from store 6 may be relevant.

Without an automated system, to effectively determine the lowest price for an item and basket of goods a shopper must go to each store and compare the prices for the desired items at the shelf, evaluating each item and each suitable substitute. Next the shopper must sift through over 100 coupons delivered on Sunday via FSI, review the shopper's mail during the week for mailed coupons, review 200-400 items in weekly retailer circulars (for all the retailers in the immediate area). Once the relevant coupons are collected the shopper would have to calculate the dead-net price for each item at each store. Once this is done the shopper would have to total up the various item options and their respective dead-net prices to determine a basket cost (for each combination) and then they can choose the lowest cost store.

Because the information is so voluminous and difficult to obtain and compare shoppers leave billions of dollars of discounts “on the table”. By way of example, of the 332 billion coupons delivered to shoppers in 2010 with an average face value of $1.46 (representing nearly $500 billion in potential savings) less than 1% were actually used or redeemed. Further, if a shopper has a 20 item shopping list, with 10 substitutable choices per item that can be purchased at any one of 5 different stores this would represent 5×10²⁰ possible combinations that would have to be compared to identify the lowest price. If the shopper is willing to visit two or more stores and split their order to increase savings, the number of combinations to be evaluated is dramatically higher still.

In Table 1 (above), a shopper buying this item at Store #2 pays almost half as much as a shopper at Store #5. To learn which store has the lowest price on this item would require actually visiting each store on the day of a shopping trip. To save on an entire basket the shopper would have to look at each item on their list and each substitute for each item at EACH store. This is a daunting if not impossible task. Still, having knowledge of actual pricing, in this limited example,—the shopper can save at least 38% everyday (Store 5 vs Store 1) and up to 42% (store 5 versus 2) for this one sale.

Today, coupons are a dull marketing tool as they are strategically challenged by an inability to effectively target an incentive to a particular audience at a particular time. For example, a “trial” coupon typically targeted at a getting a shopper to try a new product would ideally provide a 20% or more discount so as to reduce the perceived risk of trying the product. However, a marketer cannot easily give the coupon to non-users as she has no tool that identifies the non-user. Likewise, a continuity-of-purchase coupon for an existing brand user might provide a 15% savings per unit on a multi-unit purchase. For non-users, the incentive is too small. For avid brand users who normally purchase the multi-unit quantity, the trial incentive is too large. Further, if a brand's user had decided to purchase a competitive product, the brand Marketer might be interested in offering a counter incentive. However, there is no existing means of reaching a specific shopper with a targeted offer after an item has been chosen but before it has been purchased.

More importantly from a consumer savings standpoint than couponing is temporary price reduction (TPRs). Manufacturers spend an estimated $140-$280 billion annually on TPRs and related trade activity. (Nielsen Wire, Apr. 16, 2010, http://blog.nielsen.com/nielsenwire/consumer/six-trade-promotion-tips-why-less-can-be-more/ and BoozAllen report: http://www.booz.com/media/uploads/The_End_of_Trade_Spending.pdf. TPRs are funds given to retailers by brand Marketers to promote specific brands or products. Typically, a brand Marketer gives the retailer a certain dollar amount per case or unit purchased by the retailer during a time period. Retailers “pass-through” the price reduction reducing the price of the targeted item. Often however, the retailers might purchase X weeks of inventory with the TPR but sell, say X-Y at the reduced price pocketing the TPR on the remaining inventory and increasing margin. TPRs, by their nature, are untargeted with all shoppers getting the discount when it is available.

Annually brand Marketers spend over $173 billion in advertising with online, targeted, vehicles growing eight times faster at $30 billion in spending. The majority of this money is spent in traditional television and cable market though on-line is growing rapidly.

For both brand Marketers and retailers it is desirable to target marketing incentives to particular groups to maximize among other things, profits, response to promotion, revenue, inventory turns, etc. The variables that are used as targeting variable can be but are not limited to, for example, demographic information, attitudinal information, behavioral information, geographic information, weather patterns, seasonal factors, location, distance from a retailer, social variables, religion variables and more and combinations of all of these variables.

For Brand Marketers and retailers, one challenge is identifying characteristics that relate to a specific group or “target” of interest and then finding an incentive delivery vehicle that reaches the target and the target only. Currently, significant effort is placed in mathematical models that seek to derive characteristics important for a given target audience and how best to reach them with untargeted delivery vehicles. Because a screen is generally viewed by a single person, the Internet offers incredible opportunities to segment and target consumer markets. Some embodiments described herein provide the same level of target-ability that exists for web-marketers to the retail grocery business thereby revolutionizing the business and how brands are promoted to shoppers. Because the system can be used while Shoppers are in the process of shopping and on mobile devices—the system has the unique ability to target shoppers as their purchase intent (Category, brand, product, flavor, size, etc.) is revealed—BUT BEFORE THE PURCHASE OCCURS. The term “grocery” is not limited to items sold in traditional supermarkets (not just food, personal care items (e.g., deodorant), and household cleaning supplies (e.g. dish soap), but extends to any other items that may be available in a supermarket, online auction or e-tailer (e.g., eBay), club store, convenience stores, dollar store, mass merchandiser, hybrids, e-store now or in the future.

For shoppers, this system can 1. Radically simplify and streamline the grocery shopping list preparation and the item selection and purchase process, 2. increase the visibility of the retailer and Manufacturer incentive programs, 3. Enable the shopper to interact with other shoppers and friends via social means, 4. Enable the shopper to track and monitor the spending, preferences and store-level price performance and 5. Save shoppers money, 6. Save time, 7. Receive more incentives or promotional offers.

For retailers, this system can: 1. Enable the retailer to deliver marketing incentives to a targeted shopper group that has decided to shop in the retailers store, or another retail location, but has not yet gone shopping, thereby changing or modifying the Shopper's decision, 2. Enable the retailer to deliver an e-circular to a shopper as they enter a specific grocery store or retail location that is targeted to the particular specials of an individual store and can be targeted to a specific shopper of shopping list, and 3. Enable the delivery of targeted advertising via the shopper application at appropriate points during shopping preparation and execution, 4. Signal personnel where a shopper is near 5. home, deliver and pickup.

For brand Marketers, this system can: 1. Enable the delivering of electronic or e-Coupons to the shopper, 2. Enable the insertion of special incentives that are delivered after a shopper has decided what to buy but before the purchase has been made—based on decision rules and/or conditional rules—allowing for strategic and targeted incentives, and 3. Enable the delivery of targeted advertising via the shopper application at appropriate points during shopping preparation and execution and 4. Enable completely targeted promotional support instead of the current mass untargeted approaches.

The system comprises hardware, software, databases and servers, processors and communication networks, wired and/or wireless, that provides a robust, extremely fast and highly reliable experience for target customers including consumers or shoppers, retailer marketing or staff personnel and brand Marketers/staff personnel and researchers and other professionals. Some embodiments comprise four inter-linked technology platforms targeting shoppers, retailers and brand Marketers. As used herein “Basket” is used to describe a group of products (1−X) that a shopper puts on a list and intends to purchase on a shopping trip or trips. The items in the list may be specified with very specific detail, e.g., “Prego Spaghetti Sauce, 24 oz, Traditional” or more generally at the “category” level e.g., “Spaghetti Sauce.” When a shopper specifies an item on the list at the category level the shopper may have in mind very specific items (e.g., specific brand, flavor and size) that would be suitable to meet their needs, or the shopper may be indifferent between different brands of products within an acceptable range of quality and size. The system allows shoppers to prepare a shopping list using a web portal or smart phone, tablet (or other mobile device), terminal or other input device. The system could allow for the data entry of the basic list by filling out a form or making a paper list and then optically scanning the list into the device. The system them uses the scanned-in data in the manner described herein.

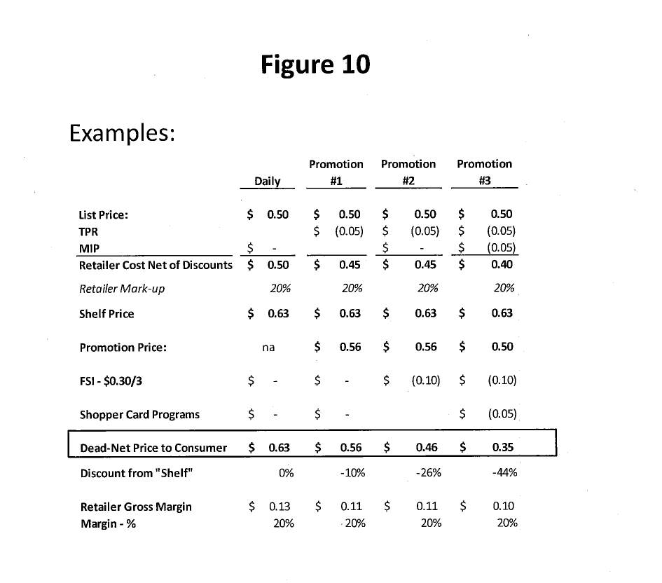

FIGS. 11-16 summarize the grocery shopping example. FIG. 11 is a block diagram of an exemplary system. In some embodiments, at least one database server provides access to the system databases, including retailer pricing/product database server 100, SKU item image database server 200, SKU/Item level retailer weekly circulars database server 300, and SKU/Item level coupon offers database server 400. The retailer pricing/product database server 100 includes: by-store, pricing zone, and individual item data for SKU #, Pricing, quantity, flavor, brand/mfg., list price, promoted price, description, and optionally other data. A plurality of retailers 1 . . . , N access the databases 100 and 300, and a plurality of product manufactures 100, 200, . . . , N00 access databases 200, and 400. Data may also be received from other external data sources 501, such as manual data entry, automated web capture, web crawlers, secret shoppers or the like. The data transmissions between the various servers and various non-transitory computer readable storage medium may be via internet, wireless or other electronic or physical means.

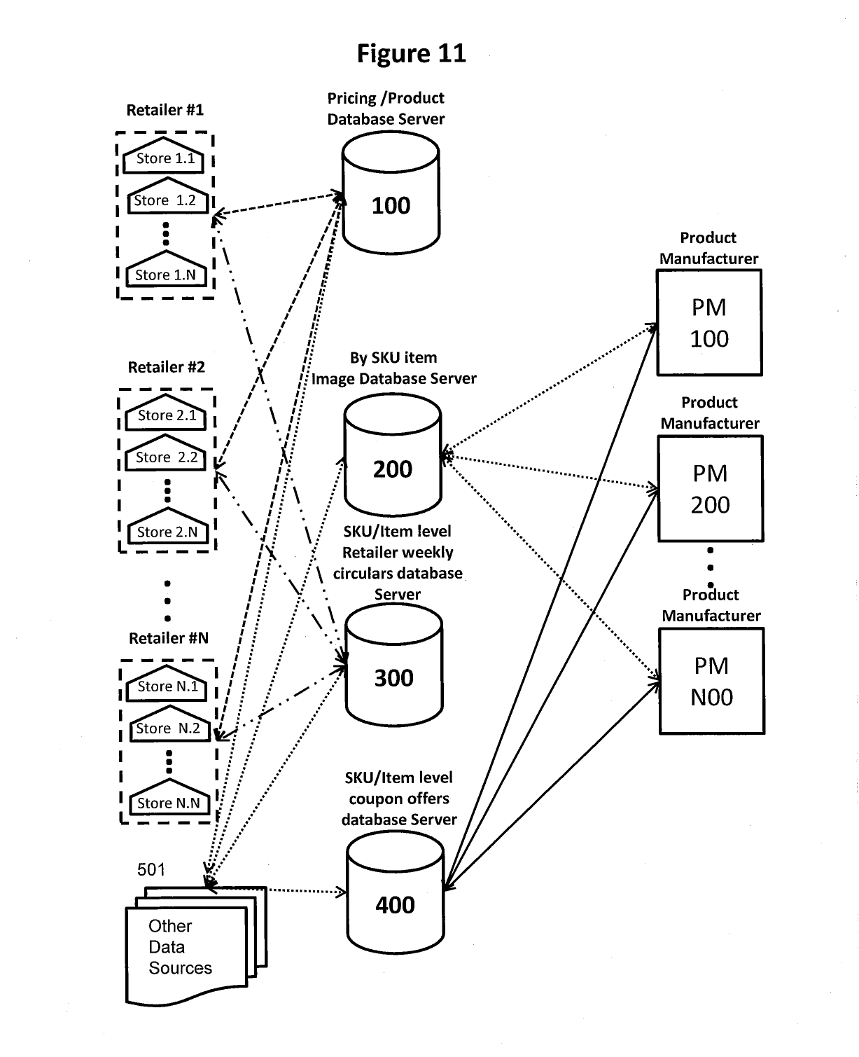

FIG. 12 shows the retailers in communication with retailer incentives database server 600, retailer location based offers database server 700, retailer advertising database server 800, and retailer logo and tag line database server 900 (which may be hosted in the same computer or a different computer from the servers of FIG. 1. The server 600 contains conditional promotional offer insertion rules, that determines the promotional offers to be made to the Shopper by Retailer within Basket Cost Minimization Algorithm impacting the Initial Lowest Cost (ILC) or a post list or basket or the FLC. Server 700 includes marketing incentives presented to Shoppers when they enter or select a specific retailer for item purchase—similar to in-store “wall of values” or in-store circular offers. Server 800 includes video interactive, and still ads for display within shopper smartphone and internet portal applications. Server 900 includes Retailer logo and tag line files for insertion into Shopper smartphone application and Internet portal applications. Logo and tag lines are also available to Retailer and Marketer portal applications. Data may also be received from other external data sources 101, such as manual data entry, automated web capture, web crawlers, secret shoppers or the like.

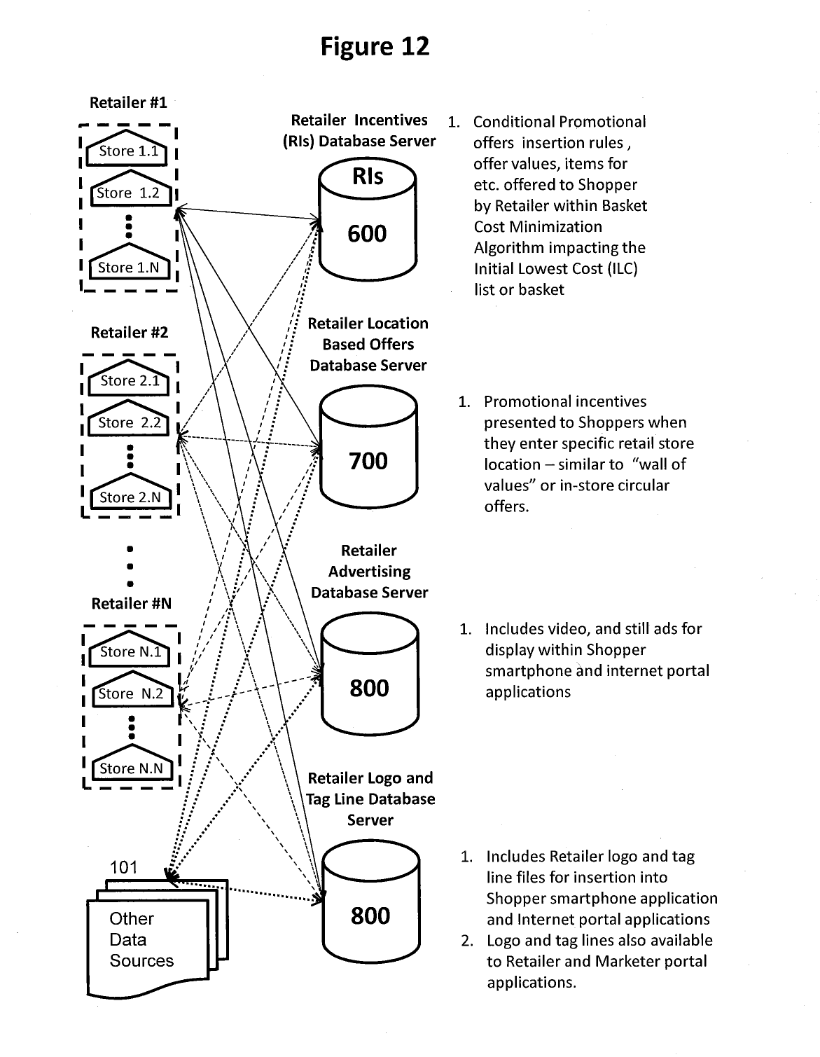

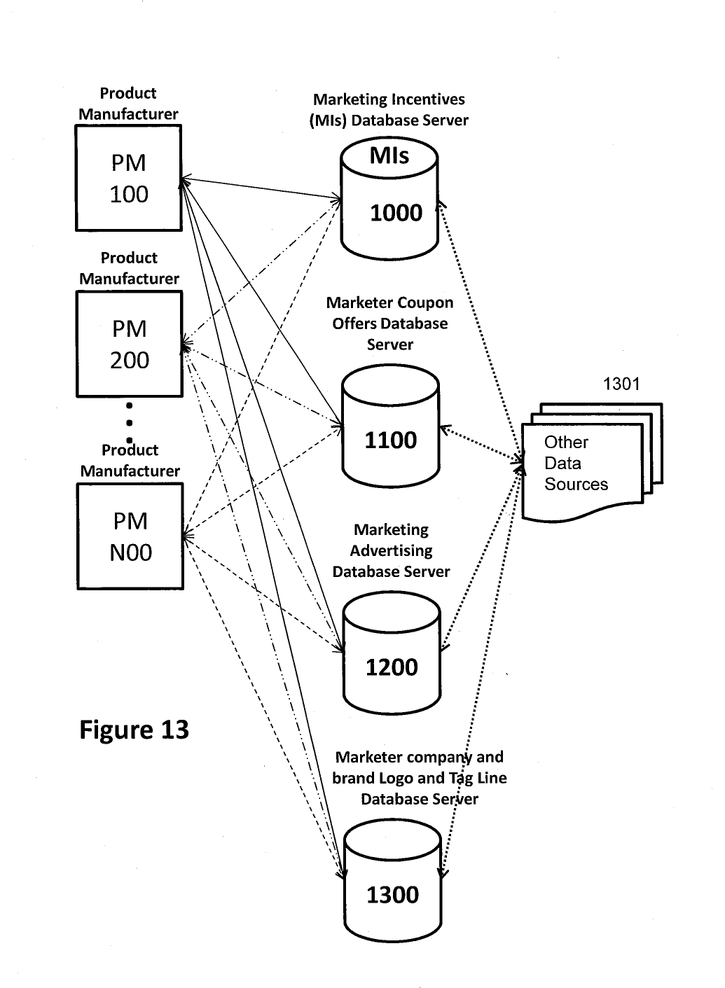

FIG. 13 is a block diagram of the product manufacturer interface. The product manufacturers 100, 200, N00 in communication with marketing incentives database server 1000, marketer coupon offers database server 1100, marketing advertising database server 1200, and marketer company and brand logo and tag line database server 1300. Server 1000 provides conditional Promotional offers, insertion rules, offer values, items or the like offered to Shopper by Marketer within basket maximization cost minimization function impacting the Final Lowest Cost (FLC) list or basket. Server 1100 provides coupon incentives delivered matching FSI or other off-line efforts for use in calculating Initial Lowest Cost (ILC) list or basket. Coupon incentives are delivered within Shopper smart phone and internet portal for use in calculating Initial Lowest Cost (ILC) for item (s) or basket. Server 1200 Includes Marketer video, and still ads for display within Shopper smart phone and internet portal applications. Server 1300 includes Marketer company logo, brand logo, tag line files for insertion into Shopper smart phone application and Internet portal applications. The Logo and tag lines also available to Retailer and Marketer portal applications. Data may also be received from other external data sources 1301, such as manual data entry, automated web capture, web crawlers, secret shoppers or the like. FIG. 14 show the shopper preference databases 1400, shopper information database 1500. Database 1400 includes information such as Location/Home Store; Other Favorite Stores—Store substitutes; Decision rules (How Shopper wants price minimization algorithm to perform relative to substitutes, such as lowest comparable price per oz, price per wash, price differential to choose brand substitutes, lowest price override, or the like; preferred brand(s) by category; Suitable substitutes by category (other brand, private label etc.). preferences for size, flavor, color or the like. The database 1500 includes name, address, log-in name and ID, demographic information, item purchase history; basket/ring purchase history; promotion response history; preferences information; pricing differential response history; and store preference history.

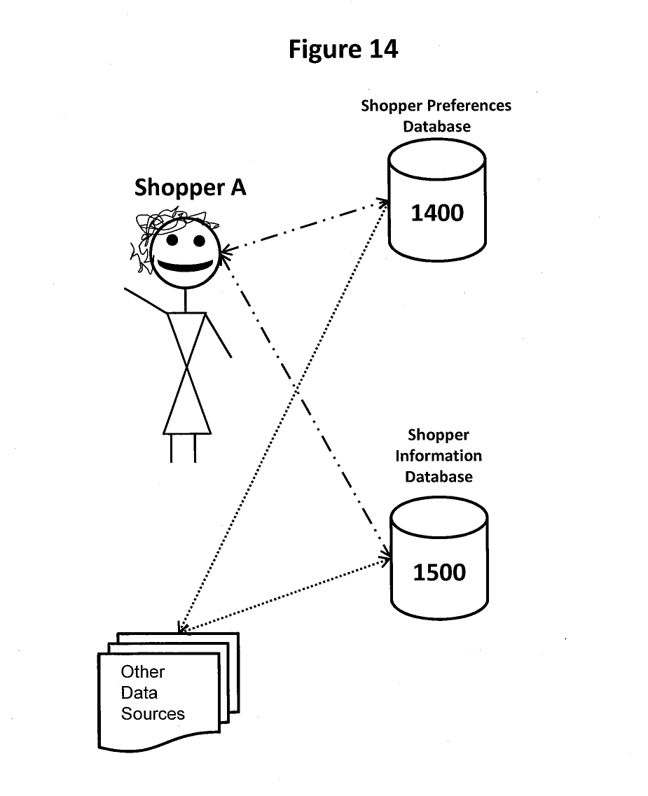

FIG. 15 is a flow chart for the method of making a list and identifying what and where to buy item(s) spending the minimum amount within defined Shopper preferences. At step 800, the shopper logs on to the website or starts the shopper app on the mobile device. At step 804, the shopper enters preferences data. At step 806, the shopper creates a shopping list. At step 808 and 810, the system issues one or more not-on-list (NOL) coupon offers for consideration. At step 812, the shopper selects “Done” ending list creation and initiating cost minimization algorithm. At step 814, the Minimization Algorithm Calculates DNP for each on the list, shopper preference identified item substitutes at all alternate retail locations. At step 816, the minimization function Identifies “Initial Lowest Cost” (ILC) list/basket and retail location providing. At step 818, a determination is made whether there are any retailer incentives (RIs). If so, step 820 is performed. If not step 822 is performed. At step 820 the Minimization Algorithm incorporates RI's and recalculates basket cost, now the “Subsequent Lowest Cost” list and retail location providing. At step 822, if there are no RIs, the ILC becomes the SLC. At step 824, SLC is displayed to the shopper along with MIs. At step 826, a determination is made whether there are any marketing incentives (MIs). If so, step 830 is performed. If not step 828 is performed. At step 830, the Minimization Algorithm recalculates basket or item cost including all MIs; the final SLC becomes the “Final Lowest Cost (FLC) item(s) or list. At step 828 the SLC becomes the FLC. At step 832, the Lowest cost for item and retail store (FLC) are presented to shopper for the shopping trip.

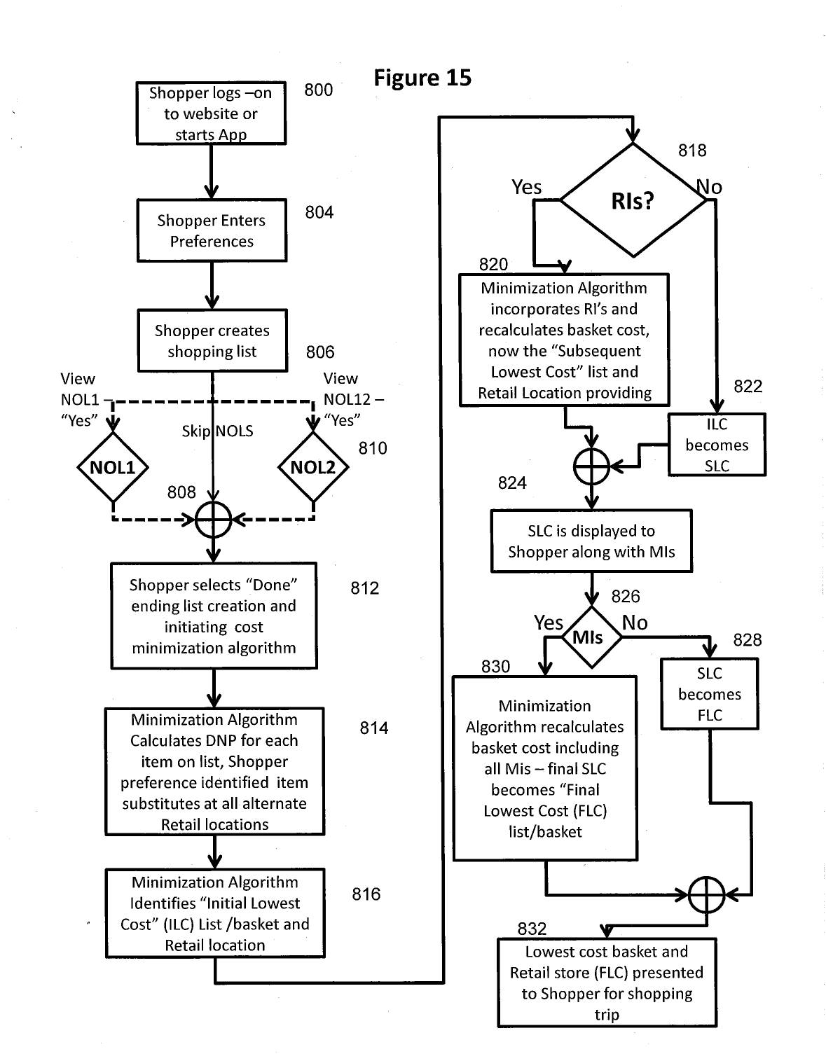

FIG. 16 is a flow chart of an example of a Retail store, Shopper uses FLC list to shop for items in streamlined fashion. At step 902, the shopper takes the shopping list on smart phone to a retail store. At step 904, As the shopper enters the store, the shopper is presented with a splash page of “In-Store Incentives” (ISIs) or Ad. At step 906, a determination is made whether the ISI is accepted. If so, step 908 is performed, and the selected Items (if any) is added to list and basket total. At step 910, the shopper picks up items on the list. At step 912, the shopper checks out, scanning smart phone or presents a frequent shopper card, frequent shopper number or other identifier to record and validate purchases, redeem e-coupons and create valid redemption record for coupon fulfillment.

The system described herein captures key shopper demographic and preference data including: decision heuristics, substitutable brands, preferred/substitutable stores or retail shopping locations, preferred sizes, flavors, packs, etc. This information comes both from internal sources upon registration and also from shared information from loyalty programs of the retailers participating in the program, as well as other external sources and co-developed sources, such as manually entered data, screen scraped data, or the like. Additional information about the user is derived from data mining and analysis of the above data.

The system can use these data in calculating the dead-net price for an item and the Final Lowest Cost (FLC) representing the lowest overall item and basket cost to the shopper, simultaneously identifying the store to purchase the list of items for the FLC cost or price. In addition to streamlining the preparation, selection and shopping process for shoppers the system allows retailers and Brand Marketers or Manufacturers the opportunity to influence shopper choice just prior to actual purchase by providing targeted incentives based on the immediately planned shopping trip list, preferences, demographics, geographic or competitive inputs, prior trip behavior, forecasted future behavior, competitive factors, weather, shopping location or other means.

Application. The system includes at least one programmed processor that automatically: 1. Matches items on the shopper's list (General or specific) to specific substitute items at the targeted retail shopping store or stores, calculates the item and overall list basket price and dead-net prices for the items and basket and recommends a specific retail store for the shopper to achieve the lowest overall basket price or cost inclusive of available retail pricing, promotions and coupons for the items on the list and suitable, shopper defined substitutes.

The greater the user's willingness to specify items more generally and purchase equivalent products of comparable quality, the more the system is able to reduce the total cost of the basket at one or more stores. The system automatically advises the user when selection of an item at a broader classification level may lead to improved savings.

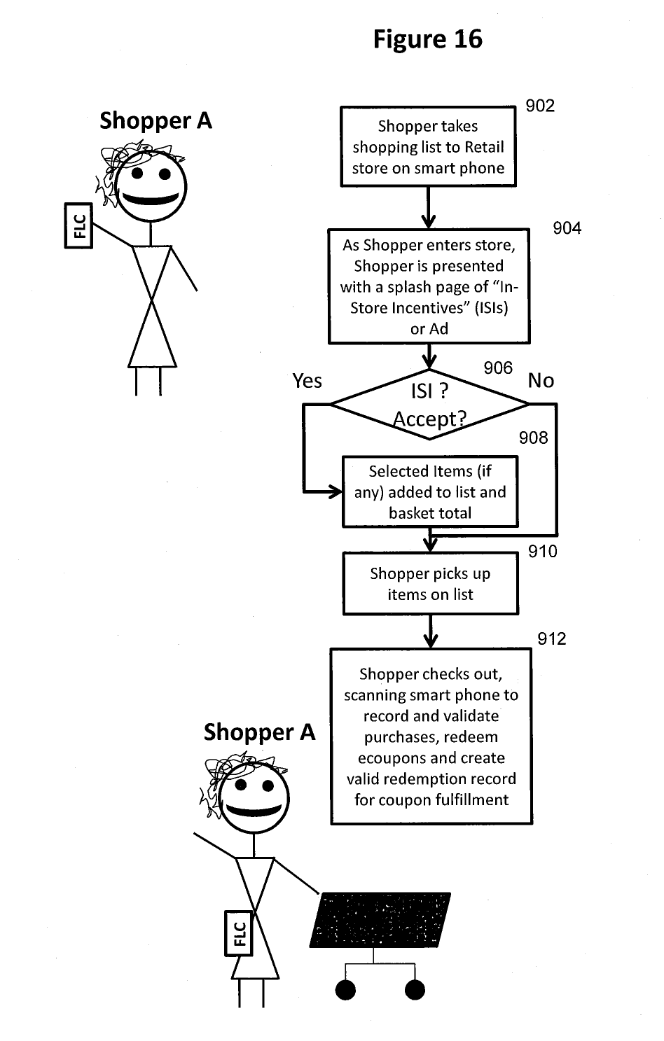

FIGS. 17A-17D show an example of this list process. In FIG. 17A, the user enters a plurality of items. In FIG. 17B, when the user has selected a sub-classification sufficiently low-level for the products remaining to be substitutes, but at a sufficiently high level that the system can select from several substitutable products to save the shopper more money. the mobile device displays that sub-classification with the ADD button. Upon selecting the “SAVEON” button, the system executes the cost minimization and identifies a basket of products and a store. The results of the computation are shown in FIG. 17C. The total basket cost and percentage savings (relative to the same items at the most expensive store analyze) are shown. Details about each SKU # are displayed, with the number of units next to it. An “Extra Savings” button next to one of the SKU #'s indicates an RI or MI that is available, and which the user can view and accept by selecting the extra savings button. For example, the system may suggest that the cost per jar is lower if the user buy's a third jar of spaghetti sauce. After the user purchases the recommended basket of items at the check out of the store, in FIG. 17D, the system optionally emails e-coupons to the user, instructs the user to print them and to check in upon entering the store (for additional offers).

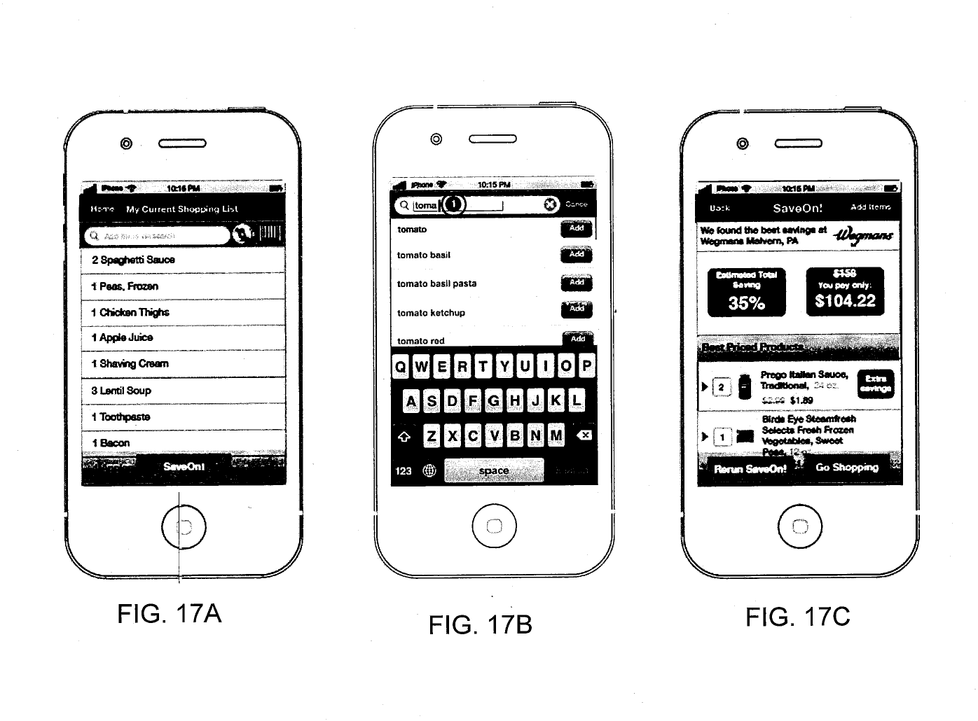

FIGS. 18A-18D are wireframes showing an example of the store check in procedure. Upon entering the store the user clicks the check in button of FIG. 17C. In FIG. 18A, if the system has recommended a first store, but the user checks into a second store, the system recommends that the user go to the first store to save more money. If the user selects the button indicating that the user still wants to shop at the second store, the system re-computes the user's basket at the second store. In some embodiments, if the user has entered a store which is not on the user's list of stores, the system prompts the user to perform a search using the system store search function, and to add the store to the user's list.

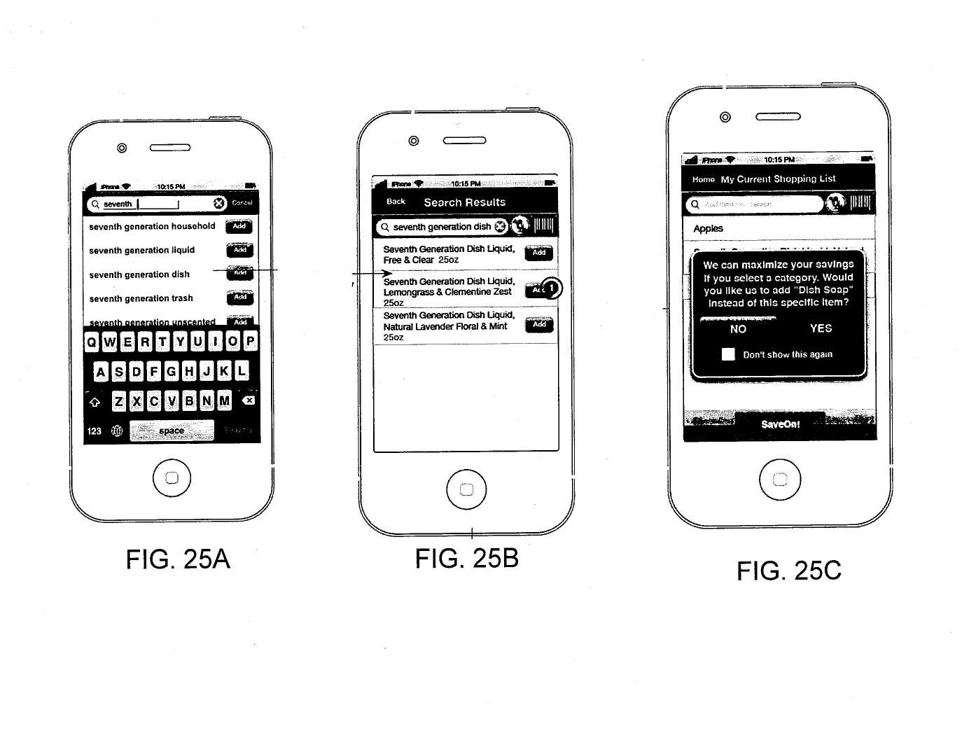

FIG. 18B shows the case in which the user checks in at the recommended store for the greatest savings. In FIG. 18B, a check in screen reminds the user to turn on location services, so that a GPS equipped mobile device precisely locates the user and automatically checks in the user upon arrival at the recommended store. FIG. 18B also shows control buttons for home, specials & coupons, my stores and my profile. The specials and coupons can assist the user in manually finding any current specials, The “My Stores” button allows the user to add or subtract up to a predetermined number (e.g., 4) of stores from which the user wants the app to recommend a store to find the lowest basket price on any given day. Selection of the “My-Profile” button takes the user to a screen for updating the user's registration information. FIG. 24 shows an example of a display for selecting stores. In some embodiments, the stores are added by the user typing in the name of the store. Each store so entered appears on the display of the mobile device with a checkbox to allow the user to select the store as a candidate for the current shopping trip (from which the system will recommend a store). In other embodiments, the user enters a zip code and the mobile device locates stores within that region as well as displaying them on a map (for example, by checking a local white pages). If no store is found an appropriate message is conveyed to the user.

In FIG. 18C, upon arrival, the mobile device app identifies when the user has reached the store, and displays an e-circular or additional in-store promotions. For example, in FIG. 18C, the user is offered a special price on a baguette, which was not part of the user's list prior to entering the store. The mobile device displays an ADD button which, if selected, adds the offered product to the user's list. In the example of FIG. 18C, there are plural offers available. The user can select one of the offers by selecting a number or the arrow on the number menu below the add button.

In FIG. 18D, the mobile app checks whether the user's profile includes a loyalty card number for the store at which the user has checked in. If not, the mobile device prompts the user to enter the loyalty card number for greater savings.

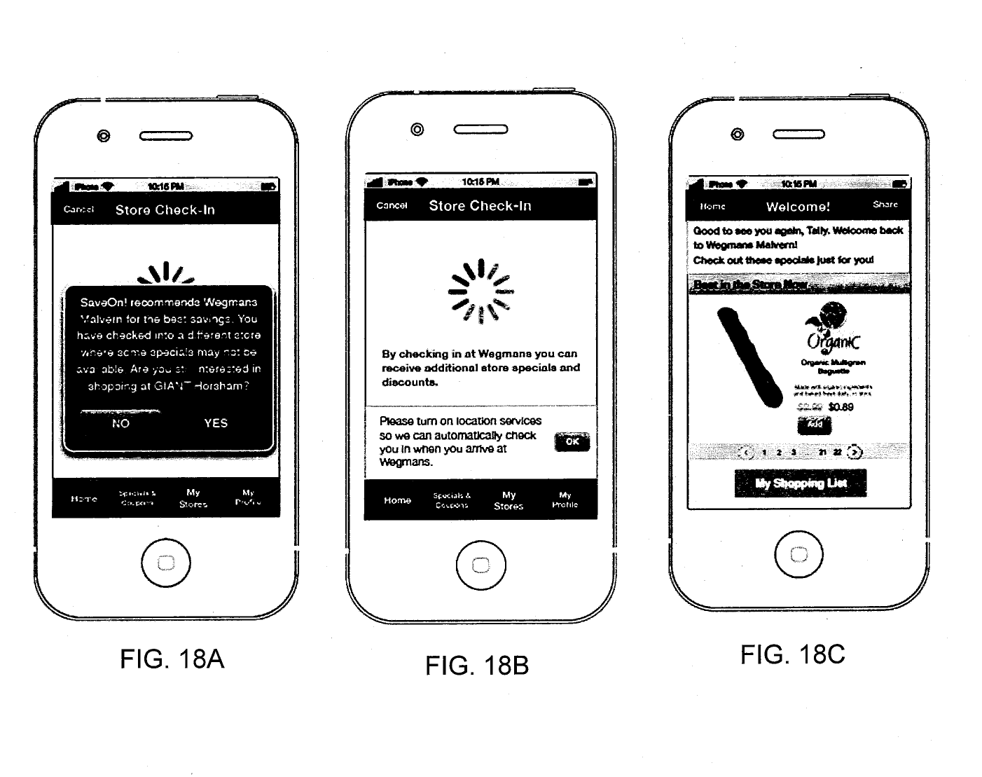

FIG. 20 shows a manual check in screen displayed by a mobile device without a GPS. Buttons are provided to enable the user to select: check in, not shopping yet, shopping at a different store, or skip check in. If the user skips check in, some offers may be unavailable to the user.

In some embodiments, the system is able to match list descriptors to specific items and then provide the shopper with a recommendation of where to shop and what to buy (item level) reflecting actual retail pricing (shelf prices, promoted prices and combinations thereof). The processor(s) running the shopping application program in essence automates the way a shopper selects a store and makes purchase decisions, in a way that was previously unachievable, thereby streamlining the grocery item purchase process. In addition, because the system is used as part of the shopper's shopping process, the system enables both retail store marketers, herein “retailers” and brand marketers, herein “marketers” to deliver marketing incentives of various kinds including additional price-related incentives, directly to the shopper during the preparation and execution of their shopping list and shopping trip. This capability is unique for the grocery industry. These incentives are included into the basket cost and can be targeted by retailers and Marketers based on a broad number of shopper characteristics, preferences, behaviors, purchase history and the like. The system further provides post and pre-shopping trip analytics to help Marketers and Retails evaluate their promotional efforts, better understand the shopper and profitably grow their respective businesses.

This system can influence shoppers after they have indicated what they intend to purchase on their shopping trip—but before the actual purchase has been made—in a streamlined highly functional application.

Some embodiments comprise a physical system architecture, software, internet web portals, a mobile device (e.g., smart phone) programmed with application(s) or “Apps”, databases, business systems and methods of capturing, analyzing information quickly to deliver in near-real time powerful analytic capabilities. In addition some embodiments includes a system for delivering electronic coupons, marketing incentives, and advertising to consumers ready to make a purchase at a retail store. Some embodiments comprise a system of hardware, software, databases and servers, processors and communication networks both wired and wireless that provides a robust, extremely fast and highly reliable experience for target customers including consumers or shoppers, retailer marketing or staff personnel and brand marketers/staff personnel and researchers and other professionals. An embodiment comprises four inter-linked technology platforms targeting shoppers, retailers and brand marketers.

The first component platform, herein the “Shopper App,” is a web portal and smartphone, tablet or other mobile access device application for consumers or herein “shoppers” that:
(1) Allows shoppers to enter a shopping list in the shopper App (for example, but not limited to 1-250 items) using a website interface or other electronic means (smartphone, tablet, terminal, computer) app by either voice command (voice recognition software), typing in a keyboard interface or smartphone touch pad/keyboard or via item scanning, photo or handwriting recognition with the smart phone/device, accessing an item look-up database as the item is typed or filled-in.
(2) Includes an item level database stored in a non-transitory computer readable storage medium, with all (or a large number) of the unique items carried in grocery retail outlets in the targeted geography (e.g., United States, Canada, France, Germany, England, Japan, China, South Korea, Brazil, Argentina, Switzerland and Denmark—or other region sharing a brand and retail base). In some embodiments, the item database can have as many as ˜500,000 unique SKUs or such amount(s) as to cover more than 50% of the items most purchased and of concern to shoppers at a retail location. In other embodiments, the database size is smaller or larger The database is highly structured with each item being dynamically categorized and tagged so as to enable rapid matching of category level descriptions to specific products.
(3) Allows shoppers to access, store and/or modify shopping preferences including favorite supermarket stores (e.g., 1-25), brand, sizes, flavors and price decision rules relating to when a product is to be considered over another or when two different brands or products are to be considered “substitutes” by the shopper. This expedites learning by the system.

In some embodiments, one of the preferences specifies the way in which price is calculated and compared (on a SKU or unit/area/count/weight basis). That is, the user can specify whether the system finds the equivalent product having the lowest cost per package (usually a smaller package) or lowest amongst a single like size to minimize this trip's cost, or the lowest cost per unit of product, to minimize total long term costs.
(4) Learns from shopper usage about the shopper's product, brand, flavor, size, pack, retail shopping location and other factor preferences. The system updates shopper specific preference database “on the fly” and incorporates such decisions in recommendations to shopper and in targeting of Marketer or retailer promotions and advertising. In some embodiments, the preference database is not updated on-the-fly throughout the day, but is periodically updated (e.g., daily).

In some embodiments, the system initializes each user to have a default set of preferences, which are subsequently updated. For example, the system may initially choose a set of default preferred products (e.g., the 3 or 4 top sellers) for each sub-classification. The system may recommend one of these products; if the shopper deselects that product, that product is dropped from the user's preferences or is reduced in rank.

In some embodiments, the learning includes beginning with a large set of prospective recommended products, and reducing the candidate set for a given user based on that user's behavior. For example, the initial set may begin with the top market share products accounting for 80% of total sales in category. This is intended to eliminate the low quality products from the candidate set. Unless the user enters a specific product outside of the top 80%, the modification of the user's preferences results in subtracting products from the user's preferences most of the time.

In other embodiments, the initial preferences and/or updates to the user's preferences may be varied based on the user's demographics. For example, the target size may be based on the size of the user's household, recognizing that large families are more likely to buy larger sizes). Similarly, if the user is older, or has a smaller family, the preference may be biased towards smaller sizes.
(5) In some embodiments, the system allows shoppers to save, re-use and delete lists, Track shopper's purchase history at category and SKU level. Allows shopper to access frequently purchased items list (at a category to SKU Level) and add items easily to a current or new shopping list.
(6) Allows family members of a shopper to access final shopping list on their smart phones. In some embodiments, the system allows the user to designate any other registered user of the system as having rights to access the user's final shopping list using their smart phone or other mobile device.
(7) Allows for specific item-level decision rules or broader decision rules (e.g., (1) Any brand in a category is acceptable, or (2) cheapest brand in a category is acceptable or (3) pick product A as the default and switch to product B if the price difference is at least a threshold percentage (e.g., 30% or more). The shopper uses the decision rules to tell the system how the shopper wants to select between similar brand or products. Decision rules comprise relevant decision variables including but not limited to one or more of price, price differential, flavor, size, pack, color, price per unit of measure, relative price per unit of measure, brand name, company, organic, sodium levels, inclusion of peanut oil or other nutrition or allergy related metrics, combinations thereof, and the like.
(8) Allows for per unit/oz/item/gram/lbs cost comparisons on all items in item and basket cost calculations (choice not driven by absolute price but comparable unit price for substitutable items. If the user's preferences so indicate, the cost comparison's can be based on actual cost for the same or similar size package or commercial unit, based on the most commonly sold size. For example, the cost comparison for spaghetti sauce may be based on the cost of a 16 oz jar across various brands and flavors, without considering the lower cost per oz or the 32 oz jars. In some embodiments, the cost comparison starts on cost per unit at a given size and does not go to larger size even if doing so would reduce the average cost per ounce/gram of product.
(9) Allows shoppers to view a list of categorized and or prioritized (on potential savings) special incentives (coupons, retailer sales or promotions or promotions presented by the system) for items that might not be on the initial planned or entered shopping list developed in #1 but merit consideration based on internal program decision rules that can be based on prior purchasing habits, significance of discount, cost of money (interest rate), purchase cycle, use up rate, and other factors relating to identifying items the shopper would have considered worth adding to a Shopping list if they were doing following a completely manual process. Selected incentives and items are added to shoppers list.
(10) Calculates for shopper, and displays almost instantly, a lowest cost list of recommended, specific, items (flavor, size, brand, pack) and at least one retail store to purchase items at so as to minimize the total basket cost within shopper defined or initial preset preference parameters taking into account all available or “live” price discount mechanisms of any kind stored in system database. This list initial recommendation is herein called the “Initial Lowest Cost” list (ILC). The processor executing the shopper App of the system displays basket cost and amount saved versus the next retail store option or one of the retail store options stored as favorite, alternative or substitute retail shopping locations if more than 2 stores are in the shoppers preference set. If only 1 store is included in shoppers preference set then the shopper App compares prices for the product representing commercial substitutes at that one store. Allows for retailer Incentives (RIs) to alter the recommended retail store outcome presented when the ILC is calculated for the shopper by the inclusion of a post-ILC incentive that further reduces the basket cost and shift the cost minimization “win” from one retailer to another as presented to the shopper in a final list. This list is herein called the Subsequent Lowest Cost List (SLC). If no retailer incentives are active the SLC and ILC are identical and the shopper is presented with the ILC. Otherwise, if an RI changes the minimization outcome, the shopper sees the SLC list only. Some embodiments permit counter RI's (e.g., retailers submit bids).

In one embodiment RI's from one or more retailers are pre-programmed and are applied to the basket totals to calculate SLC basket. In another embodiment, retailers “bid” in a real-time or preprogrammed fashion for the shopper's basket such that the winning “bid” becomes the winning retail store that the algorithm will then present to the shopper. In one embodiment the RI's are applied to the basket cost and then a second or more rounds of RIs are accepted until no more RIs are available to further reduce the basket cost. In one embodiment a group of shoppers puts their baskets up for a bid wherein retailers can agree to sell the shopper or group of shoppers the item or items of the respective baskets at a specific price. Other embodiments do not permit counter RI's.
(11) Displays a shopping list for the shopper that includes a “check box” icon or other similar graphic device or icon for items in the shopping cart and a visual icon indicating whether additional Incentives (MIs or RIs) are available for a particular item on the shopping list.

The icon when pressed will display MIs that may be accepted by the shopper and result in: the replacement of the item in shopping basket that was immediately adjacent to the icon, recalculation of basket cost and inclusion of additional incentives relevant to item and basket costing. MIs can also increase the amount of the items in the basket that the offer is associated with and can add another item to the list, a manufacturer may decide that, anytime the consumer is a large household, the basket is greater than a threshold value, and the customer lives in a particular zip code, the manufacturer wants want to offer $10 more off their basket. In various other embodiments, the offers may be own-brand types of offers to encourage the shopper to buy more product, or competitive switching offers, to try to persuade the shopper to try a different brand instead of the brand on the user's list, These MIs and RIs are made after the ILC is calculated, and with a high degree of knowledge about what the consumer is about to do.

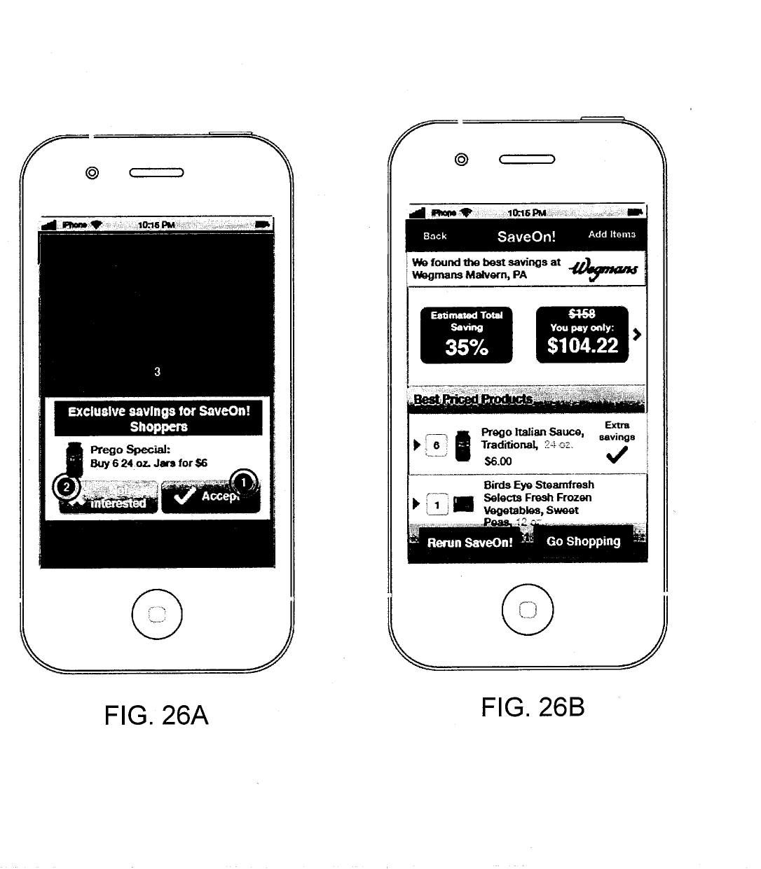

FIG. 25A-25C show the operation of the “Keyword to Category to SKU Funnel Logic” which enables a user to enter a string or keyword, make a small number (e.g., 1 to 3) sub-set descriptor selections, and receive from the system a display of commercially equivalent products. It the remaining items in the sub-set are sufficiently similar to be considered substitutes, an ADD button (or similar selection device) is displayed next to each remaining item. If the user clicks the displayed ADD button for selecting a sub-set descriptor to the user's basket (without ADDing a specific SKU), the user has specified enough information for the system to make an automated minimum cost selection among equivalent products, and the system will recommend the lowest price product to satisfy the item on the list.

Proceeding from a list to a recommendation:

Consumers make lists of broad categories of items they wish to purchase when making a shopping list. In some cases, for the items on the list, the user may have in mind a specific brand or group of brands that can meet that product need. Likewise, they have sizes, flavors, and types that can meet their need. In other cases, the user may be indifferent between products of comparable quality, size, flavor and type, and want the system to recommend the least cost alternative. Further, if the user has input a list of stores containing more than one store at which the user is willing to purchase the basket of products, the system can recommend the store at which the total cost of the least expensive basket is minimum.

To maximize savings for shoppers, the system prefers that the shopper not be overly specific. That is, the system allows the user to specify a narrow descriptor sub-set having a small number of SKUs, or even to specify a single, specific SKU; but if the user does so, the system issues a message suggesting to the user that the system can provide greater savings if the user selects a higher level, classification (broader sub-set descriptor), and allows the system to recommend a minimum cost basket based on a lower cost substitute product, To effectively minimize cost, the system requests that the shopper selects a classification level (corresponding to a sub-descriptor) specific enough in defining a product so the shopper App can initially recommend and display a reasonable set of items (e.g., 20 to 30) from which the system or the user can select the one of the recommended items having the lowest cost.

### Example

If the shopper types in “Bread” the user could mean “A loaf of bread,” “Bread Crumbs,” or “Bread dough.” Initially, the system does not know enough about what the shopper means or wants to make an effective recommendation or run the cost minimization algorithm. The system can display these sub-set descriptors and allow the user to select the next lower level classification. Assume the user selects “A loaf of bread.” The system can then give the user a sub-set choice between fresh baked bread (from the in-store bakery) or pre-packaged bread from an outside supplier. Assume the user selects “pre-packaged bread”. The system can then display the next lower set of sub-set descriptors, which may be “white”, “whole-wheat,” “rye,” multi-grain, and “brioche,” In some embodiments, at each level, the sub-set descriptors are pre-determined so as to be mutually exclusive, and to be completely exhaustive of the available products at the stores on the user's store list. That is, at a given level, each sub-set descriptor or product that is within the classification at that level is contained within exactly one sub-set at the next lower classification level. By eliminating overlap between different sub-sets at a given classification level, the system is able to quickly reduce the number of products from which the system will either seek to further reduce the number of recommended products from which to make a recommendation, or from which the system will actually make the recommendation.

If the shopper selects “whole-wheat”, the user has identified a sub-classification containing commercial substitutes. There are now a suitably small set (e.g., fewer than 20) of brands, sizes and types of pre-packaged whole wheat bread, from which the system can select the lowest price product. Once a level containing commercial substitutes is reached, the system displays an “ADD” button. Optionally the system allows the user to manually select their favorite SKU by “whole wheat” display as brand choices. If the user makes a manual selection, the user's preference for this type of whole wheat bread is recorded in the database. The system also reminds the user that more money can be saved if the user selects a sub-set descriptor instead of a specific SKU, and allows the system to make the selection. If the user does not make a manual selection of a specific SKU, or if the user returns to the “whole wheat bread” classification subset, the system selects the lowest cost loaf from the set. Specifically, the lowest cost pre-packaged whole-wheat bread.

This Keyword-Category-SKU Funnel allows the shopper Apps to start with a reasonable approach to selecting a specific item for consumers (as outlinedabove) and then quickly utilize “learning” to refine the approach over time.

Logic Outline:

The system has a database which is organized into several (e.g., 10-11) classification levels. The shopper begins by typing in a string or keyword. As a shopper types, the shopper App of the system begins a keyword search of meta data, text, or of the available item database. In some embodiments, the database is organized so that at level 6, each of the classification sub-set descriptors defines a set of commercially equivalent, same or similar products. The sub-set descriptors or SKUs at or below this level are displayed to the user with an ADD button, indicating that the remaining items within that sub-set are considered commercially equivalent substitutes so that the system can make an automatic selection from that sub-set without more lower-level selection by the user. The classifications above level 6 are arranged so that it is generally possible to traverse the index from a search term (e.g., bread) to the level containing commercial substitutes within three or some other small number (e.g., 2) sub-set descriptor selections. Although the system allows the user to continue to drill down to level 0 or the lowest level, the greatest savings potential is provided when the user clicks the ADD button to add to his or her cart the sub-set descriptor for a broader sub-set.

When the shopper first enters a search string, for each specific item returned, the search algorithm (SA) displays the unique Level 8 outcomes. So if the user searches on “soup” and there are items that are described with the term “soup” in three level-8 groups the system causes the user's mobile device to display the three level-8 groups For example, the system can display, “soup,” “soup mix,” or “soup base.”

Selecting the Level-8 group that corresponds with what the consumer wants (e.g., soup), the system will cause the MD to display the appropriate level 7 groups that go with the level 8 selection. (e.g., Ready-To-Eat, Condensed, Powdered, Mix).

Selecting the level 7 group that corresponds to what the user wants (e.g., Condensed) will display the level 6 groups that correspond. (e.g, for a selection of “condensed,” the level 6 groups of “chicken noodle”, “beef”, “chicken with rice”, etc. are displayed,) and ADD. In this example, the level of specificity is low enough, e.g., the Level 6 descriptors are items considered commercial substitutes, for the system to quickly make a selection, or for the user to make a manual selection.

Selecting the level 6 group that corresponds (e.g., chicken noodle) will display the level 5 groups that correspond to that sub-set descriptor. For example, the sub-set descriptors may be “chicken noodle” and “homestyle chicken noodle”.

Selecting the level 5 group will display the Level 4 brands groups that correspond with Level 5 (e.g., Campbell's, Wegmans, Acme, Progresso).

The system allows the user to optionally continue to define further attributes that can further reduce the solution set. The database is optimized so that the greatest savings can be realized if the user allows the system to select a product, once the user has made enough classification sub-set selections to reach a sub-classification in which all of the candidate items are commercial substitutes for one another, so that the system can select and recommend the lowest priced remaining candidate item. Generally, the database is organized so that this level is reached by the time the user has drilled down to level 6 of the index. The consumer can continue to drill down to Level 1 or the lowest populated level. Selecting a lower level sub-set descriptor or specific SKU using the ADD button after level 6 will result in a message such as, “We can save you more if you choose [level 6 name]”. If the user completes the selection and ADDs the lower-level sub-set or specific SKU to the user's cart, the system includes that specific product in the basket at each store, but continues to determine lowest basket cost at each store by automated selection of a recommended product corresponding to each other item in the user's list. (That is, the system recommends the lowest price product from amongst the pre-defined commercial substitutes, unless the user has ADDed a specific SKU to his/her shopping cart). If a specific SKU is added the system includes that item in the basket. On the other hand, if the user elects a sub-set descriptor at Level 6, the system adds that level 6 sub-set descriptions to the list and will later optimize on price looking at all commercial substitutes represented by level 6.

The system permits the user to search on at least one string descriptor and find any product from the at least one preselected store in less than a predetermined number of inputs. This predetermined number can be 10, 9, 8, 7, 6, 5, 4, 3, 2, or 1.

FIG. 25 shows an example in which the user inputs the string “seventh”. The mobile device displays several sub-classifications including the term, “seventh”. The system displays the next level sub-classification descriptors, including “seventh generation household,” “seventh generation liquid,” “seventh generation dish,” “seventh generation trash,” and “seventh generation unscented,”

If the user selects the next lower sub-classification “seventh generation dish” then the sub-classification descriptors including that string are displayed, as shown in FIG. 25B. In the case where the sub-classification has fewer than a predetermined number (e.g., fewer than 20), all of the specific SKU #s are displayed with the ADD button. Thus in FIG. 25B, the user has reached a smaller sub-set of substitutes than is desired for minimizing price. By entering a specific string, the user has reached a lower level of the index (below level 6).

In FIG. 25C, if the user uses the ADD button to add one of the specific SKU #s to her shopping cart, the system displays a reminder that the system can potentially save more money for the customer if the user specifies a category instead of an SKU#. The mobile device suggests adding “dish soap” instead of “seventh generation dish liquid, lemongrass & Clementine zest.” If the user accepts this suggestion, then the item in the shopper's list is changed to “dish soap.”

Each successive selection acts as an additive (“Boolean”) filter to what is displayed. For example, assume there are 1500 items listed with “bread” in the description, with 3 level-8 groups of 500 products each. Once the Level 8 selection is made the search is now only considering the 500 products of the combined filter of “bread” and Level 8 group.

In some embodiments, all the sub-set descriptors at a given classification level are mutually exclusive, and each remaining product at a classification level corresponds to exactly one of the sub-set classifications at that same level. In other embodiments, the database can be organized so that there is some small overlap between different sub-set classifications at that same level. For example, a rye-whole-wheat loaf may be classified under, rye bread, whole wheat bread and multi-grain bread. By defining the sub-set descriptors to minimize the number of such overlaps, the number of levels of selection through which the user drills down before a reaching a sub-classification containing only commercial substitutes is reduced.

In other embodiments, a small number of miscellaneous items at a given classification level may not correspond to any of the sub-set descriptors in that level (in which case, selection of any of the sub-set descriptors at that level or a lower level will eliminate that small number of miscellaneous items from being considered in the final automated product selection. For example, an item may be eligible for selection by the system at level 6, if the user clicks the ADD button on a level 6 sub-set descriptor, but excluded if the user makes a selection at a lower level.

In some embodiments, the system uses a Rule of N—(where N is a predetermined input variable, for example, N=20) This rule permits the user to make fewer selections if the initial search by the user corresponds to a lower level (e.g., level 5 or 4) sub-classification and only a few SKUs correspond. The algorithm will follow the steps described above. If the total number of remaining SKUs (after application of the combinations of the applied filters) at any level below level 6 is <=N (e.g., <=20) items, then the algorithm will display those items for optional user selection immediately. If the highest level at which the number of remaining items (after application of the combinations of applied filters)<=N (e.g., <=20) is level 6 then the algorithm will display the level 6 results with the ADD button. Once the user has clicked the “ADD” button, the user has provided sufficient information for the system to make an automated selection of a lowest price commercial substitute products at each store, corresponding to one of the items in the user's list. If the user has ADDed a sub-set identifier, the system adds the item (with whatever level of specificity the user has provided) to the user's basket for cost comparison between stores amongst similar items.

The rule of N does not continue beyond level 6. The shopper can continue to drill down and specify additional sub-set descriptors, which act as filters, but the rule will no longer be used. E.g., Suppose the selection of “Banana Bread” results in 4-SKUs remaining at a retailer, the algorithm will display Banana Bread-Loaf, Banana Bread-Mix, Banana Bread-Muffins. The routine follows the steps outlined above but does NOT make the user click at Levels 10, . . . , 1. Rather, the system will display the lowest level (higher of 6 and 5) with ADD buttons immediately.

In some embodiments, if the results of the initial search <=20 (at Level 6) then the items will be displayed with description of Level 6+Level 9. E.g., if the user searches, “Whole Wheat Tortilla” the search returns and displays “Whole Wheat Tortilla” (redundant Tortilla is eliminated).

Search Terms are additive in a Boolean sense. E.g., Whole wheat Tortilla searches for items with the terms “Whole AND Wheat AND Tortilla” will be matched against Level 3−Level 10 descriptors, high level item description, detailed item descriptions

In some embodiments the algorithm will do an OR search of multiple keywords entered at levels 10 through 8 AND Level 6-3. If there is a match at level 8 AND a match at Levels 6-3 the system will display subset of the identified level 8 categories which also match at level 6. If there is no match at levels 6-3 then the matching level 8 categories will be displayed; a standard (single keyword) drill down will start and the remaining rules of a simple search outlined herein will follow for the remainder of the search.

Price Minimization Algorithm (MAP) Performance

Once the user has selected a respective item (sub-set identifier or SKU) for each item in the user's list, the system uses a price minimization algorithm, to find a local minimum price that satisfies the user's list. The result is a referred to herein as a “minimum,” in that the total set of possible combinations is initially trimmed to reflect the user's selection of stores and preference settings. It is not necessarily the absolute minimum among every product sold at any store. Further, in some embodiments, the total set of products in the database which are considered as substitutes is trimmed to include a predetermined percentage (e.g., 80%) of the products of a given type. For example, stores may carry 30 different types (brands) of canned 10.5 oz cans of condensed chicken noodle soup. If 80% of all sales of canned 10.5 oz cans of condensed chicken noodle soup are made up of only the top ten sellers out of the 30 products, then the database can be trimmed to exclude the 20 products which make up the remaining 20% of total sales. Although one of these excluded products may have the absolute minimum price, if sales are used as a proxy for quality and preference, then the top selling products making up the 80% of total sales are viewed as having comparable, acceptable quality or as preferred by most shoppers. Thus, the top sellers are considered by the system as being substitutes for each other. The minimum price determined by the system is not an absolute global minimum price, but a minimum price of a basket of products satisfying the user's preferences and meeting a level of market share or quality established by the administrator of the system database or users. The user's preferences further allow the user to select a higher quality standard, so that only the products identified as “super-premium products” by the administrator are considered for this particular user, if there is a premium product version of one of the items on the user's list.

Setup/Structure:

1. In some embodiments, the system assigns an initial default set of preferences to each user. In some embodiments, the system provides the user with series of options for preferences, and allows a new user to self-identify his or her own preferences or affinity group(s). For example, in a grocery store setting, the system can allow the shopper to select a preference for super-premium food products. If the user selects this option, then the set of candidate products suggested to the user is reduced to exclude lower priced/lower quality items. This may be done by ranking the products according to price and selecting those products priced above a cutoff price as candidates, or may be done by manually selecting the group to include in (or exclude from) the candidate set, or it may be done by the user, or it may be done by crowd source opinion of what products are “super premium”. In another grocery store example, the system can allow the shopper to identify himself/herself as an extreme bargain hunter, in which case all products in the database (possibly including some products of lower quality and large sized units with lower price per ounce) are included in the initial candidate sets for that user. In this manner the system can establish a variety of product preference “presets” that represent different approaches to considering products as commercial substitutes and the shopper can select one of these presets as an initial starting point for their system preferences. Once the shopper begins using the app the system will optionally modify these initial setting to match the Shopper's actual behavior. The system creates for each shopper a database of product substitutes (SdBPS) that will have the following initial presets—

a. For each product category the system will pre-define a number of default top brands (e.g., the top 4 brands) or products that make up the majority of sales volume. In the Preference Engine these 4 brands will be considered perfect substitutes for each other. For example: Category=Spaghetti Sauce, Brand 1=Prego, Brand 2=Ragu, Brand 3=Francesco Rinaldi, Brand 4=Classico's. The system receives as inputs sales data for various products, which the system sorts by sales volume, and from which the system automatically identifies these top sellers, which are stored in the database. Alternatively, the System Administrator determines which product makes up the bulk of user demand.

b. For each category the system will pre-define a main product size or package that represents the majority of sales on a size or pack basis. For example: Category=Spaghetti Sauce, Main product size=24 oz. In some embodiments, the system correlates demographic information with size (e.g., households having four or more people most often choose the 32 oz. size, but households having 1-3 people most often choose the 16 oz. size). This information can be used in conjunction with the information obtained from the user during registration, to set the user's pre-defined size, via pre-sets or other setup capabilities.

c. For each Brand-size combination the system will identify specific flavors or items that are similar. For example: Category=Spaghetti Sauce, Flavor=Tomato Basil is the same as Tomato & Basil and Tomato and Basil.

2. Shoppers will have previously selected up to a predetermined number (for example, but not limited to, 4) of stores that the shopper considers acceptable substitutes from a shopper perspective. That is, these stores satisfy the shopper's criteria for convenience and perceived value. In addition the shopper will have created an initial shopping list of items at the categories and/or specific item level.

3. The system provides a real-time database of individual products including

a. Categorization of each item at brand, sub-brand, size, flavor, pack and other descriptor levels (e.g., Organic, hormone free etc)—. The categorization according to levels will be based on a fixed or “dynamic” structure for different product categories, e.g., thereby effectively below 10 levels.

b. For each item and store/price zone, the system will also keep a table or database of shelf prices and deadnet price (the price of an item incorporating all promotional discounts of any kind including coupons, temporary price reductions, shopper card discounts etc.)

c. For each Category and each item in a category and store/price zone, the system will calculate the comparable price per unit (e.g., deadnet price/oz).

4. Shoppers typically make a list of “category” descriptors—e.g., “Soup.” Shoppers know what they consider suitable matches for the descriptor “Soup.”

5. When a shopper types in a category item—e.g., “Soup” the App of the system performs a matching routine that will identify the specific item at a low enough level in the data architecture (Level 6 or Level 5 in the Table 1 example). The matching functions as follows:

a. An item added to the list is keyword matched to the highest database product level, corresponding to the descriptor, in the database of all grocery store items. Here, “Soup” is matched to level 9 and 8 sub-set descriptors, but it appears uniquely in level 8. Thus, the algorithm then returns Level 7 descriptors for selection. E.g., “Condensed, Ready-to-Eat, Mix, Microwaveable”

b. The shopper then selects one of the Level 7 descriptors. E.g., The shopper selects “Ready-to-Eat.”

c. Once the shopper has selected the Level 7 descriptor, the app now treats the selected descriptors as additive filters (e.g.: in Boolean terms, “Soup” AND “Ready-to-Eat”) and returns the descriptors of Level 6 that remain from this search.

d. The App displays Level 6 descriptors which represent in Table 1 “flavors.”

e. Selection of a Level 6 descriptor is sufficient for the App to make pricing choice decisions and so the App displays an “Add” button next to the flavors displayed in Level 6. E.g., App displays “Chicken Noodle, Tomato, New England Clam Chowder.” The shopper selects “New England Clam Chowder”.

f. If the shopper would like to drill down deeper and be more specific the app allows the shopper to tap on the displayed item to move to levels 5, 4, 3, 2, 1, 0 filters with the “Add” button displayed at each level. The system does not always use all 10 levels. The string or keyword initially entered by the user may correspond to a lower level sub-classification descriptor. Further, the user may choose the ADD button at one of the intermediate levels (e.g., level 6), so that the system can choose the least expensive product at an intermediate level.

g. If the user makes a selection at levels lower than necessary (for the system to automatically identify a set of equivalent products and recommend a lowest cost product among them) the system provides a warning message explaining to shoppers that more money can be saved by allowing the app to make tradeoffs at higher (less specific) levels within the database.

6. When the “SaveOn!” function is selected and run items on the shoppers list (Pre-Algorithm List) may be described by the Shopper in degrees of specificity ranging from broad to specific. All items on the list are described at a level that is at least as specific as to identify commercial substitutes within the product category. All items on the list are specified at most at the SKU level. For each item the MAP will look at related items (either related commercial substitutes, a more specific level of categorization but no more than SKU). For each item the MAP will compare the dead-net prices/unit of all substitutable items, if any, for each category, identifying the lowest priced item (price/unit) for the first store of the up to the predetermined number (e.g., 4) of stores selected above.

7. The MAP proceeds to make the same comparison for each item on the Pre-Algorithm list, until the lowest priced item is identified for each item (as now identified by the selected classification and sub-set descriptors) on the Pre-Algorithm List at the first store.

8. The MAP then conducts the same type of comparison for the same Pre-Algorithm list of items at each of the selected stores—Store 1, Store 2, Store 3 and Store 4 . . . Store N). Note that the basket of products selected at each store, corresponding to the pre-algorithm list, can contain a different set of SKUs for each respective store. The system takes into account the actual prices at each store.

9. When the lowest priced basket is identified for each of the selected stores—the basket costs are then compared across stores and the lowest overall basket and store combination (the Post-Algorithm List) is identified and presented to the shopper.

10. In certain cases the app may first calculate the total basket cost at a retailer so that retailer coupons that are based on a specific basket cost target can be reflected prior to inclusion of other coupons or sales that might put the basket below the targeted amount.

11. The MAP also identifies the highest priced basket-store combination looking at the same size, category combinations identified for the lowest priced basket for each store. Thus, in this computation the same basket of products which is the lowest among all of the stores is then priced at all of the stores. The result is an “apples-to-apples” comparison for a basket of specific products (brands, sizes and flavors) at each of the selected stores.

12. When the lowest, and highest, priced basket-store combination has been identified, the system displays the lowest priced Post-Algorithm List along with the name of the target store (i.e., the store having the lowest total price for the basket). The savings level and total basket price for each store is also provided within the app for consumers tapping on display of “winning” store results.

13. When the Post-Algorithm list is displayed (specific items) the following are also displayed:

a. For each item on the recommended list, icons showing what types of discounts were incorporated into the final price are displayed next to the item (e.g., an icon for coupons, an icon for price reductions, and Icon for shopper card promotions)

b. The basket total cost is displayed along with the $ and % savings versus the highest priced basket-store combination identified above in #8. In some embodiments, the savings are calculated relative to different reference points.

14. The system then looks to the web-based direct marketing Campaign Management System (or other reference points) to see if any offers are available on the items in the Post-Algorithm List and store recommendation. If there are available offers, the system will signal the shopper that additional savings are available. The signal will be clearly associated with the relevant Post-Algorithm List items.

15. When a shopper selects an item that has an additional offer associated with it, the offer details are presented (e.g., Shelf price, $/off, deadnet price, purchase requirements and brand/item details). Shoppers can accept or reject the incremental promotional offer. “Accepting” the extra offer will cause the Post-Algorithm list to be updated to reflect any changes in brand, size, purchase quantity, flavor necessary to accept the offer. The total basket price is updated and displayed along with updated $ and % savings versus the Highest-Priced basket with the same change made in the highest-priced basket (but without any discounts) by the selection of the promoted item.

16. Once the Post-Algorithm List is presented, the shopper will be allowed to change recommended products by tapping an item and then responding/navigating through a series of filters to the desired item.

17. When a shopper changes a recommended product on the Post-Algorithm List, the SdBPS from #1 above will be updated as follows:

a. The selection of a Brand not previously flagged as a substitute in the SdBPS, will cause a flag to be set for that item as a suitable substitute in the SdBPS. The flag for the brand being de-selected will be set to the “off” position or weighted differently in any preference algorithm. Brands not flagged as substitutes will not be compared in the MAP and will not appear in a post-algorithm list until flagged.

b. The selection of a different size not previously flagged as a substitute in the SdBPS, will cause a flag to be set for that size as a suitable substitute in the SdBPS. The app will dynamically monitor size selection within a category and after a variable number of “deselections” the size deselected “N” times will be set to the “Off” position. Sizes not flagged as substitutes will not be compared in the MAP and will not appear in a post-algorithm list until flagged.

c. The selection of a Flavor not previously flagged as a substitute in the SdBPS, will cause a flag to be set for that item as a suitable substitute in the SdBPS. The flag for the flavor being de-selected will NOT be set to the “off” position. Flavors not flagged as substitutes will not be compared in the MAP and will not appear in a post-algorithm list until flagged.

Special Cases and Situations

1. Private Label Products: Private label, store brand and generic products may be automatically selected as suitable substitutes within the SdBPS. The system will determine in the initial presets which products are top sellers and suitably close in quality as to be considered suitable substitutes. Products that are of significantly low or lower quality than the top selling items in a category will not be flagged as substitutes. “Top selling” is to mean those products and brands making up—80% of a category's sales and for which general consumer preference is positive. The system and the App will seek to avoid recommending products that may be the cheapest—but have by individual consumer choice in the market—been deemed unacceptable or of significantly lower quality.

a. Within the system setup screen on the app/website a global function will allow the user to override the Private label approach described above and include or exclude

ALL private label products or other products from their personal SdBPS and the MAP.

2. Super Premium Products: Super Premium Products will automatically be pre-selected as suitable substitutes within the SdBPS. Consumer generally recognize these items as being “better” but choose not to purchase them because of their higher price. Because of this, the system may operate on the assumption that if these items are low enough in price, or on sale, shoppers would be happy to have them appear on the post-algorithm list. The system will determine in the initial presets which products are top sellers and suitably close in quality as to be considered suitable substitutes. Products that are of significantly higher quality (and price) than the top selling items in a category are flagged as substitutes. “Top selling” means those products and brands making up a predetermined percentage (e.g., ˜80%) of a category's sales. While these products may be flagged they will not likely be recommended by the MAP unless they are on sale and reach a unit cost that causes them to “win” in MAP—or the shopper changes preferences by using app or actively changing preference settings.

a. Within the system setup screen on the app/website shoppers will be able to include or exclude Super Premium, or any specific products, from their SdBPS and the MAP, as discussed above with respect to Presets If they desire the MAP to only look at Super Premium Products they can simply deselect the current or preset products in their SdBPS and select the Super Premium (or other) items. The system will then use this new set for the MAP analysis.

3. Organic/Free-Range/Wild/Hormone-Free products: Organic/free-range/wild/hormone-free products are automatically pre-selected as suitable substitutes within the SdBPS. Consumer generally recognize these items as being “better” but choose not to purchase them because of their higher price. Because of this, the system operates on the assumption that if these items are low enough in prices shoppers would be happy to have them appear on the post-algorithm list. The system will determine in the initial presets which products are top sellers and suitably close in quality as to be considered suitable substitutes. Products that are of significantly higher quality (and price) than the top selling items in a category are flagged as substitutes. While these products may be flagged they will not likely be recommended by the MAP unless they are on sale and reach a unit cost that causes them to “win” in MAP. Alternatively, the system will also include certain descriptors in the database architecture—e.g., Level 0 of Table 1 so that these items can be added easily to a shopper's list and SdBPS.

a. Within the system setup screen on the app/website shoppers will be able to include or exclude organic/free-range/wild/hormone-free (or any) products from their SdBPS and the MAP. If they desire the MAP to only look at organic/free-range/wild/hormone-free they can simply deselect the current or preset products in their SdBPS and select the Super Premium (or other) items. The system will then use this new set for the MAP analysis. If there are sufficient organic/free-range/wild/hormone-free products in every category the system will make this a global preset; but if there are not sufficient organic/free-range/wild/hormone-free products in every category the system will do this on a category-by-category or product-by-product basis. In other embodiments, the system allows the consumer to start from scratch in creating a personalized SdBPS, e.g., no presets, so the SdBPS is built by list creation. In this case, all items on the list are specific. Alternatively, the system will capture nutritional and other product level descriptors that may include information relating to these attributes for each item in database.

4. Multiples: Marketing incentives are often provided for consumers buying more than one of a given product. E.g. $5.00 off when you purchase 10. For the purposes of the MAP analysis, the system will consider purchase multiples of standard sizes (the top selling size that will be assumed by the MAP to be the main preferred size) up to a predetermined number (e.g., three (3)) in determining the lowest price per unit under the assumption that consumers would be willing to purchase up to this number (e.g., three (3)) of most items. The system learns the individual user's preferences in this regard after the shopper has experienced this situation.

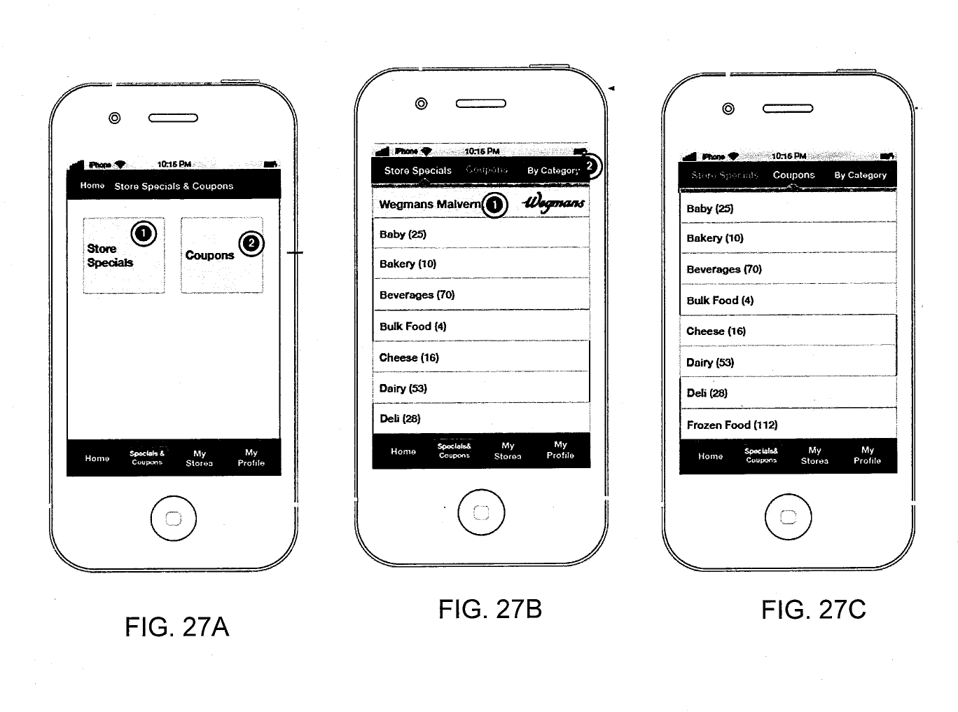

a. Within the system setup screen on the app/website a global function will allow the user to override the Multiples approach described above and include or exclude ALL Multiple promotional offers in the MAP. For example, FIG. 26A shows a screen that may be displayed if the user overrides the multiples approach, and includes all multiple promotional offers. Although the user's list requested 1 jar ($1.89), the offer provides six jars of the same product for a total of $6 (a 47% saving). Thus, if the shopper is willing to consider all multiple promotional offers, additional savings can be realized. FIG. 26B shows the display after the user has tapped the “Accept” button. The quantity is automatically changed from “1” to “6” and the extra savings indicator is shown. The estimated total savings and total cost are updated.

5. Bundle Packs: Items are often packaged in bundles or with multiple units in a pack, e.g., toilet paper, 12 rolls. Bundle Packs are treated as suitable substitutes within the SdBPS as preset by the system. The system administrator will decide in advance what level of bundling is typical and appropriate and will cause these items to be flagged as suitable.

a. Within the system setup screen on the app/website a global function will allow the user to override the Bundle Pack approach described above and include or exclude ALL Bundle Packs promotional offers in the MAP. If ALL bundle packs are included, then the quantity of an item bundled in one store is increased on the user's list, so that the same quantity is priced at all the stores.

6. Incomplete Lists: When the MAP runs, if a store in the comparison set of stores (up to 4 or N) does not have at least a predetermined percentage (e.g., 80%) of the items on the initial list, then the store will be dropped from the analysis except in the special situations detailed below:

a. If a store “B” has fewer than the predetermined percentage (e.g., <80%) of the items on the list, but except for these items Store B has the cheapest basket cost, and the savings is as least a preset opportunity cost (e.g., $10.00) then the system will present the Store B as the winner in the MAP and visually indicate that certain items are not available at Store B and indicate the single store of the stores that the MAP ran against that has the best price for these items (Split basket). This provide the user with an opportunity to realize savings by splitting the basket between two stores.

b. If all of the stores have fewer than the predetermined percentage (e.g., <80%) of the items then the MAP will compare prices on the items that are available at all stores and notify shopper that the winner is being evaluated from commonly available products.

7. Cherry Picking: Cherry Picking involves shopping multiple stores within the same week to maximize savings by purchasing predominantly sale items at two (or more) stores. By buying at multiple stores the shopper can maximize the sale items available. A significant portion of “store switchers” exhibit this behavior frequently (20-50%). Within the system setup this behavior is supported with a global select that will enable the shopper to split their basket in up to four (2, 3 or 4 stops). The MAP will run as it did in through step 7 above but the MAP will look for bundles of items across multiple stores that further reduce the overall combined cost. The system allows shoppers to set a minimum savings value (opportunity cost) that is used to judge whether Cherry picking/basket splitting is worthwhile and only pursue this strategy when the savings exceeds the opportunity cost.

In some embodiments, the system allows the user to input a number of stores (e.g., 2 to 4) at which the shopper is willing to split his or her order. In some embodiments, the system exhaustively computes all the combinations in which any subset of the products is priced at one store and the remaining products are purchased at a second store. The system can first do the normal (non-split) price computation at each store to compute the basket cost at each of 4 stores. Then the system assigns to each store the products for which that store has the best price, recomputes the divided baskets at each store (taking out incentives that no longer apply when the total order is divided), and then compares the result to the single store cost.

In some embodiments, the database includes a field for each product to identify whether the product is hypoallergenic or specially directed towards a segment of the population with low tolerance for a certain food (e.g., ciliac disease, diabetes, or the like). If a shopper is buying one of these products because of the absence of allergens and the system were to substitute something with an allergen not knowing the reason why the original product was chosen, the system would not provide the desired recommendations for the user. Some embodiments provide a warning or algorithm override for items that are known to be special diet in nature. Then the system notifies the shopper with a warning to be sure they specify specific items if an allergy concern is present.

2. The system assembles a proprietary database of items that are “same” e.g. sauce varieties and sizes.

4. The system assembles a proprietary database of top selling sizes

5. The system assembles a proprietary database of substitute brands/products

6. In some embodiments, the size substitution algorithm only goes “1 up or 1 down” in size to avoid sizes that are inappropriate for small households. If the system collects individual household data the system can go 2 up/down for large households

7. In another embodiment, user preference inputs can be provided for and engine to provide:

a. Whether Alternate size substitution is OK

b. Whether Alternate brand substitution is OK? (baseline substitutes are provided for items in the basket, and products are identified where the shopper has NO substitutes

c. Whether Private label brands are acceptable as substitutes.—

d. Whether Nutritional/Allergen info filters are desired.

8. Some embodiments account for opportunity cost of shopping at multiple stores—the entire second trip except in-store shopping time is costed as being incremental., (Driving, gas, parking, loading, checkout are all considered to be an incremental costs). Driving time and cost are incorporated by looking at distance and shopper entered gas and time cost. Without shopper input, the App of the system uses average fuel price in the area of the shopper to determine cost of driving.

Referring now to FIG. 8 after each MI is reviewed and selected a new final list and basket cost are calculated with a total cost for the basket and savings versus next store displayed. Once all MIs are considered or no more are selected the list is a final list. This list is herein called the Final Lowest Cost list (FLC).

The system presents other retailer marketing incentives in a virtual “e-in-store circular”, “e-circular” or “e-wall of values” format that may include a pop-up-screen on the smartphone, tablet, terminal, or other mobile device. The e-circular is presented visually to the shopper when, and only when, they enter a specific retail location (location based service). Service can be enabled by a variety of location based approaches including GPS, blue-tooth, FLC, cell tower triangulation or other methods.

In other embodiments, the MIs and RIs may be keyed to seasons and basket contents in combination. For example, the retailer can have an RI within two weeks of Thanksgiving geared toward selling turkey, cranberries, pumpkin pie filling on and stuffing mix. In one embodiment, upon the user entering the store, if any of those four products is missing from the shopper's list, the system suggests to the user that he or she should purchase the missing item, and tell the user the sale price and aisle number. In another embodiment, the system only makes the suggestion of the user's list includes from 1 to 3 of the items (but not all four).

In another embodiment, the system notifies the store when the shopper is within a pre-determined distance in travel time so that pre-picked grocery baskets can be brought to a pick-up location for the shopper's convenience.

Items can be selected and are “added” to shopper FLC list.

Items may or may not change retail store recommendation once an item's cost is added to shopping basket total.

Once the shopper has completed shopping, and items have been rung up by a cashier or automatic scanning system, the Smartphone application presents a number scan-able bar code, blue-tooth signal, LED or near field communication (NFC) enabled signal to record the purchases and link electronic coupons, and shopper card incentives to the shoppers identity, to reduce basket cost appropriately and provide purchase record for validation.

The shopper App of the system captures consumer demographic information, purchase information, preferences and decision rules and other information relating to purchase behavior.

The shopper App and supporting systems are compatible with standard and widely used platforms, such as the iPhone (Apple OS), Android (Android OS) and Blackberry devices (RIMOS), Microsoft and related tablets, terminals and other mobile or stationary devices that can aptly deliver functionality.

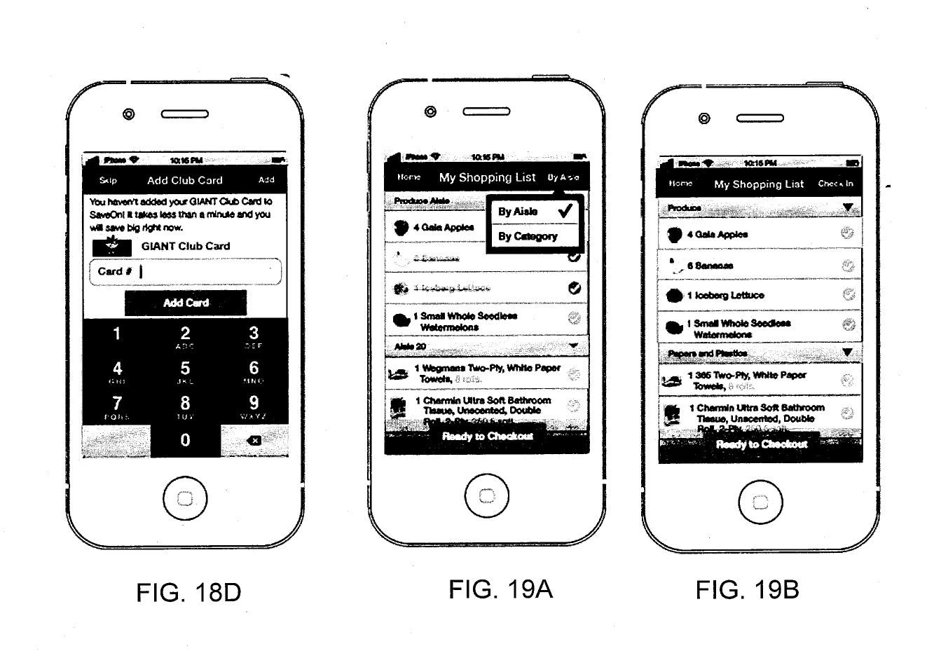

In some embodiments the system allows the shopper to share shopping list and final purchase price with self-defined or other defined social networking peers, and allows the shopper to share store specials or other sales or products found at a retail location with friends or peers in a self-defined social network. FIG. 21 shows an example of a screen in which the user has selected the “share” button, in response to which the mobile device displays a set of icons for selecting a sharing/communication method, such as Facebook, Twitter, short message service (SMS) or email.

In some embodiments, the system provides links to permit the user to share and compare their savings with friends, to see who can save the most. In some embodiments, gaming techniques allow users to play shared games relating to shopping and saving using this system. Based on the user's behavior during the games, the system can extract additional information about the user's preferences. For example, in a game with options, the user's selection of options provides an indication of what the user likes, so that the system can use this information to populate/update the user's preferences. In some embodiments, the system provides the user tools for tracking how the user is doing against the user's own savings goals. The way the user uses these tools can further indicate the user's preferences.

When the shopper presents the mobile device at the point of sale station in the selected store, the system collects point-of-sale information from the user transactions and stores this informational along with all demographic, behavioral, pricing basket items, and promotion information.

The system further comprises an analytic engine for evaluating promotional offers and tracking performance of the offers. The system databases associated with user preferences learn by adapting to user inputs and purchases choices to continuously enhance fit. The system collects and updates items, item and store level pricing and promotional offers periodically. For example, the period can be monthly, every 3 weeks, every 2 weeks, every week, every day, or live updates.

The second component platform, herein the “Retailer Portal,” is website based portal for grocery retailers or herein “retailers” that:

includes a web-based direct marketing campaign management system for grocery retailers that allows retailers to influence shoppers to shop at their store(s) by offering incentives to shopper and/or select target audiences. The target audience(s) can be selected based on shopper characteristics. As used herein, “shopper characteristics” includes the following individual items or combinations thereof: demographic characteristics, psychographics or affinity groups, name, household location, past buying history, total basket price, specific item(s) in the basket, number of items in the basket, combinations of items in basket, time of year, date proximity to major holidays, date proximity to social events, date proximity to religious dates or holidays, date proximity to political events, family size, shopper preferences or decision heuristics, current basket of items, past basket items, estimated use-up rate for items, weather re-order recommendations, at-home inventory for items, geo-location, location in store, and other factors.

Allows supermarket retailers to develop and execute conditional price incentives, RIs that are used in the calculation and display of the lowest cost basket and shopping location (store) recommendation. Incentives can be based on any individual or combination of shopper characteristics detailed above or other information available.

RI incentives are presented at the point of store decision—when the shopper activates the shopper App algorithm to select the best store to shop at to obtain the lowest item and basket price amongst target store set. In some embodiments, RI's are presented post minimization, with MI's.

The retailer portal also has a basic and advanced analytics module to analyze shopper behavior and promotional performance. The basic functionality is accessible through the standard retailer portal web site and campaign management system. Advanced analytic capabilities are offered via a fee based portal for Promotion and shopper Analytics and be available on a subscription, fee, consulting or other revenue generating basis.

The third component platform, herein the “Marketer Portal,” is website based portal for brand marketers, herein “marketers” that:

Is a web-based direct marketing campaign management system for brand marketers that allows marketers to influence shopper's purchasing a brand or category at the moment that a purchase decision is being made by presenting a purchase incentive or advertisement as the shopper is creating and or finalizing a grocery list prior to a shopping trip(s) or item purchase.

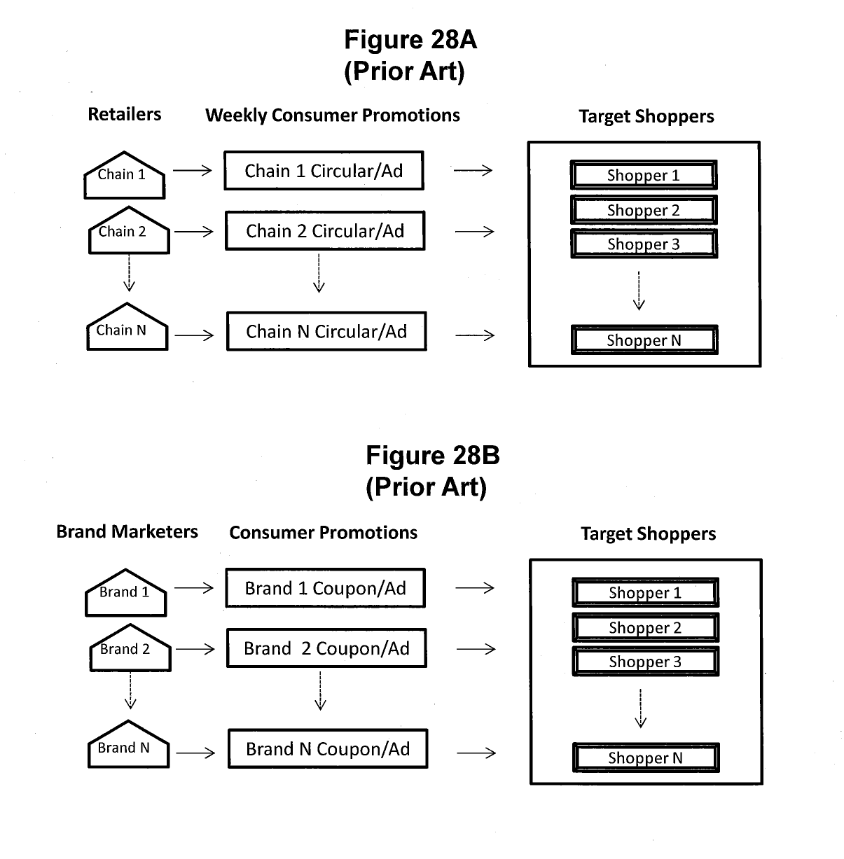

FIGS. 28A and 28B show traditional methods of distributing direct mail circular and coupons, respectively. Traditional consumer promotions from both Retailers and Brand Marketers have been broadcast to large audiences with little or no customization. Retailers distribute weekly circulars notifying all shoppers of the same specials available in their stores. These circulars can be tailored to a group of stores, but they are not tailored for each specific shopper. Brand Marketers deliver a coupon or advertisement to an extremely large audience hoping to reach interested and relevant consumers.

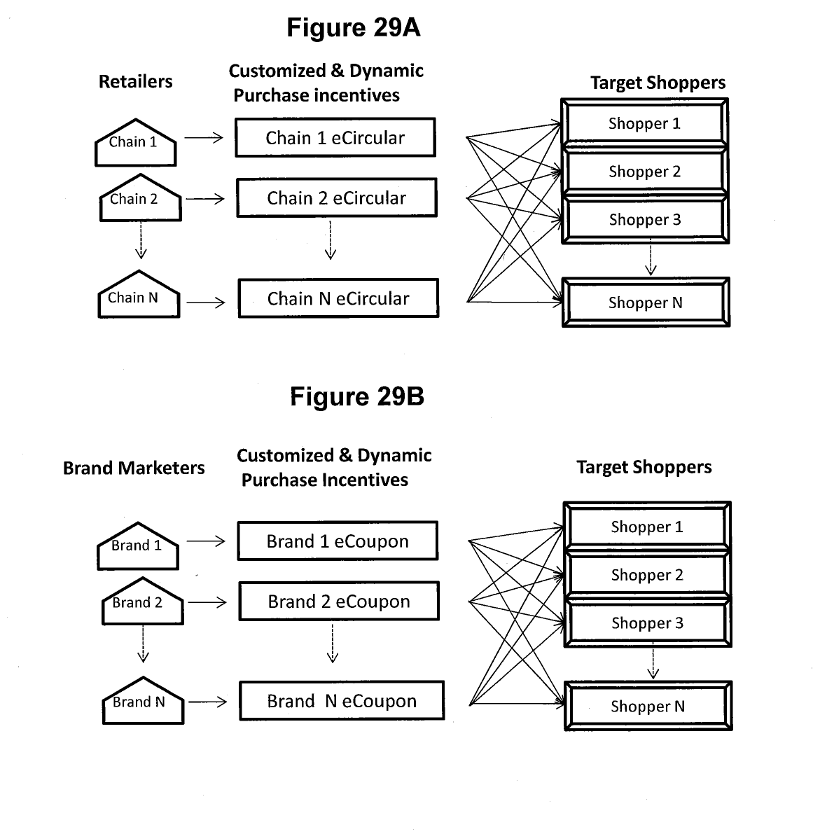

FIGS. 29A and 29B show an embodiment of a method of electronically delivering e-circulars and e-coupons through a processor or mobile device running the shopper app. Promotions delivered through the shopping app are completely customized and delivered in real-time based on inputs received by the system. Rather than creating a circular for an entire store or set of stores, retailers can craft circulars for specific customers taking into account factors such as their purchase history, profitability, and intended purchases in their upcoming shopping trip. Pricing and promotions can be delivered dynamically and in real time in response to shopper actions, behaviors, preferences or competitive pricing available in the marketplace. Brand marketers can deliver custom e-Coupons, incentives, and advertising to specific shoppers based on data such as that shopper's past purchase history, their demographics, or their current purchase intent.

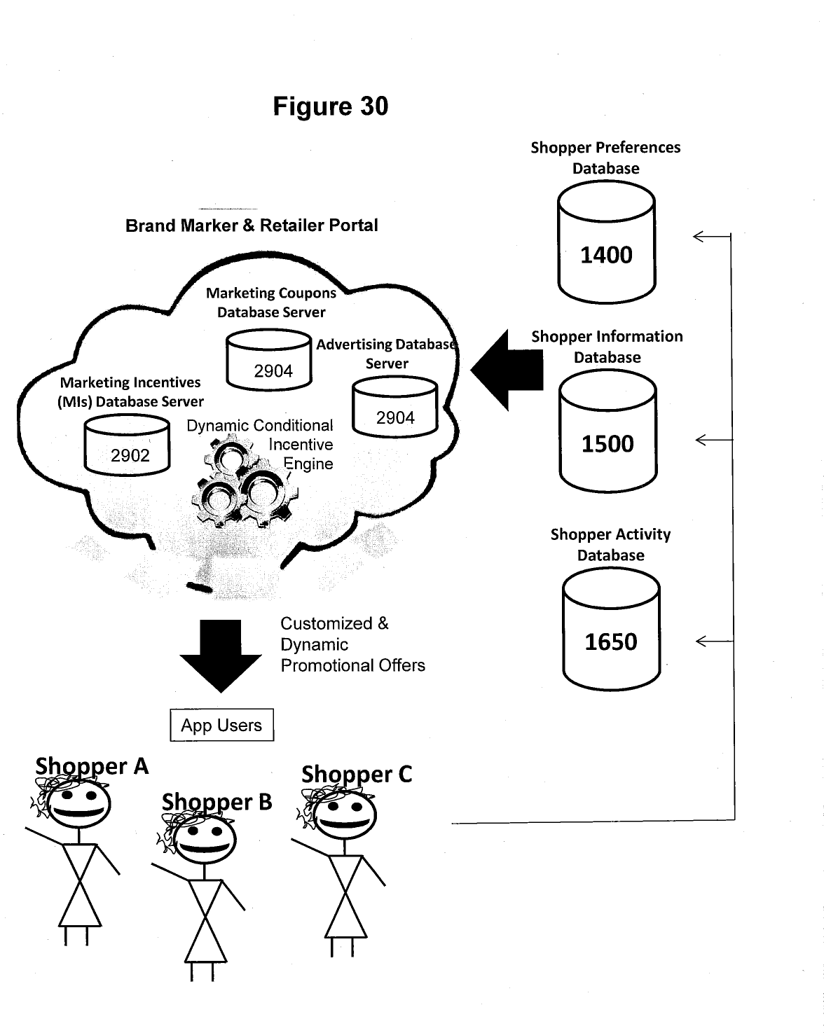

FIG. 30 is a block diagram of a web-based campaign management system. The web-based campaign management system is used by retailers and brand marketers to manage the promotions delivered to consumers via the app. Within the brand marketer and retailer portal Brand marketers and retailers can create incentives—marketing incentives 2902, coupons 2904, and advertising 2906—that are delivered to shoppers dynamically and in real time based upon the shopper's current activity 1650, shopper information 1500, or shopping preferences 1400. App usage populates the shopper activity 1650, shopper information 1500, and shopper preferences 1400 databases. The web-based campaign management system takes real-time input from these databases and dynamically delivers customized promotions to specific targeted shoppers.

As used herein, purchase incentives can include, but are not limited to, e-Coupons, electronic delivery of FSI coupons, price discounts in the form of reduced prices or TPRs, additional incentives, or incentives of any kind—herein “MIs” or Marketer Incentives to be incorporated in the shopper App to calculate FLC as detailed above. FIGS. 26B, 26A. There are many other incentive and advertising/messaging incentives that are well known to marketing professionals that may be included in the functionality of the Marketer Portal, retailer Portal and shopper App. This may also include incentives pre-final basket delivered electronically and POST final basket run that can change final choice or quantities in final basket.

The system provides targeted coupon and advertising/message delivery based on shopper Characteristics as defined above. Advertising messages can be still, video, flash, pop-up, or any other type of message and delivery approach familiar to App and web-site developers.

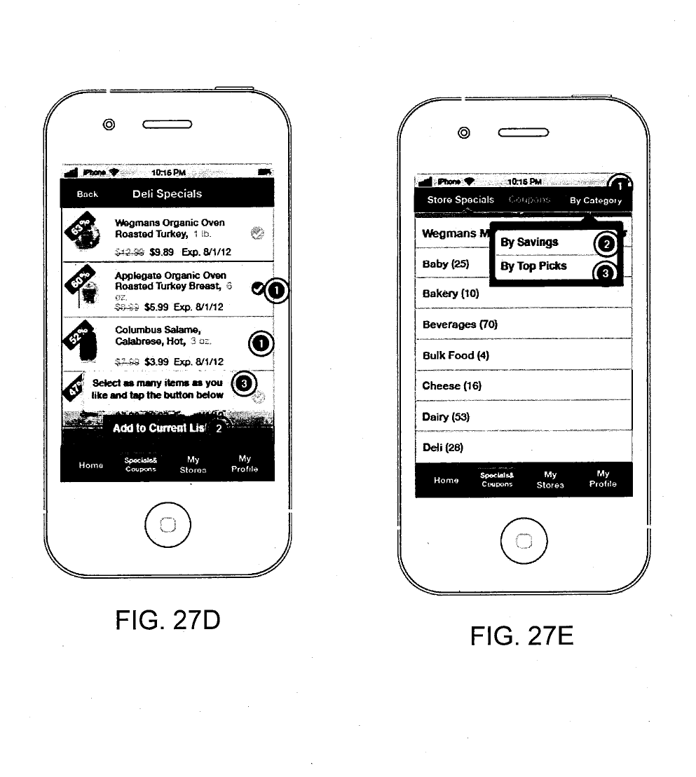

FIGS. 27A-27E show an example of an interface for presenting coupons and offers to the user. In FIG. 27A, the user is presented with choice of viewing store specials or coupons. In FIG. 27B, the store specials are sorted by category, and the user can select any of the categories to view the store specials thereof. In FIG. 27C, the coupons are sorted by category, and the user can select any of the categories to view the coupons thereof. FIG. 27D shows the listing of one category of specials in response to selection of that specials category. Each product on special is displayed with price, expiration date, savings, and a selection checkbox. FIG. 26E shows an additional sorting capability provided in some embodiments. Upon displaying the categories, the user can select a pop up menu for sorting the specials by savings percentage, or by popularity (as measured by the number of purchases by users of the system.

The marketer portal also has a basic and advanced analytics module to analyze shopper behavior and promotional performance. The basic functionality will be accessible through the standard web site portal and campaign management system. In some embodiments, advanced capabilities can be fee based and accessible on subscription basis.

In some embodiments, the system bases the driving distance on the location of the user's home GPS location to calculate drive costs. In other embodiments, the system computes driving distance and cost based on the current location of the user based on other methods (e.g., cell phone tower location).

The fourth component platform, herein the “research portal,” is website based portal for marketers and retailers and other customers that:

Enables complete post and pre-event analysis of offers and shopper behavior for the purposes of targeting, incentive design, costing, response analysis, competitive analysis or other purposes as needed by retailers, marketers or other customers to better drive sales, profitability and shopper understanding and insight.

The fourth component is alternatively a stand-alone portal and integrated as a section of the retailer can brand portals.

All four component platforms are integrated and supported by a robust, extremely fast and highly reliable system of hardware and software that:

Periodcially captures (e.g., on a daily basis, or more, or less frequently, as desired) item level shelf pricing for all items in all grocery stores (pricing zones) in a target geographical area (including individually or together the United States, Canada, France, Germany, England, Japan, China, South Korea, Brazil, Argentina, Switzerland and Denmark—or other region(s) sharing a brand and retail base and including as appropriate the major retail formats for grocery food and non-food items including supermarkets, dollar stores, grocery stores, convenience stores, mass-merchandisers, “supercenters” as data is available with a goal of covering the majority of important market outlets. In some embodiments, the system collects and updates items, item and store level pricing and promotional offers every month, every 3 weeks, every 2 weeks, every week, every day, or “Live” updates throughout the day.

Accounts for all, or nearly all, temporary price reductions,

Accounts for all, or nearly all, pricing discounts of any kind,

Accounts for all, or nearly all, retailer shopper loyalty card programs or incentives,

Accounts for all Coupon incentives.

Allows for capturing FSI coupon incentives delivered in newspapers.

Allows for completely electronic coupon incentives to be included by Marketers.

Prevents mis-redemption or simultaneous usage of both electronic and FSI versions of the same coupon delivered on a specific item by a Marketer.

Helps prevent fraud or various forms of mal-redemption for coupons and other incentives.

Allow for linkage or integration with retailer shopper-card and loyalty programs

Allows for post-trip and shopper preference analytics and reporting and other data mining analysis to support fourth technology platform.

Allows for rate card and bid-based (e.g., Adwords) pricing, billing and tracking on all advertising/awareness vehicles.

Allows for bid-based pricing on all incentive vehicles including MIs, RIs and any coupons.

Allows for a level or category exclusivity for specific Marketers and items.

Allows for a level or category exclusivity for specific retailers or stores.

Allows for delivery of short still, video, or interactive advertising messages sponsored by retailers or Manufactures or other delivered on select pages of the shopper App or web portal.

Allows for scalability from as small as one chain and one store to as large as all chains and stores in a target geography. For example in the U.S. the system may cover approximately 25,000 retail outlets, 150,000 unique SKUs and 100 million shoppers.

Allows for billing retailers and Marketers Fees for incentives, ads, and/or messages of any kind

Allows for billing of retailers and Marketers for system setup and Portal access or subsystem.

Allows for optional billing of shoppers for shopper App and web-site portal usage.

Allows for institution of a pricing hierarchy with incentives based on degree of targeting, incentive amounts and a pricing algorithm may take into account market demand, exclusivity, category size, competitive substitutes, elasticity(s) and cross-price elasticity(s) and other factors relevant to maximizing revenue; allows pay-per-click or pay for performance pricing.

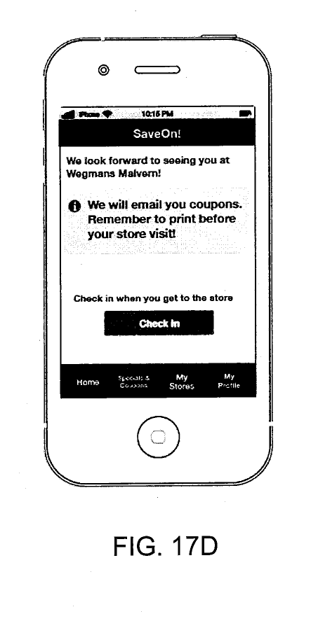

Allows for the incorporation of store schematics, aisle—plans or floor plans, shelf plans into the app. In some embodiments, the system sorts the final list for the user by aisle when the user enters one of the stores (based on the layout of each individual store), letting shoppers know in which aisle to find their list items. FIG. 19A is an example showing the shopping list sorted by aisle. Each item also has a checkbox the user can use to check off items as they are added to the shopper's physical shopping cart. The screen has an “aisle” button, selection of which causes the mobile device to display a popup menu for selecting either sorting by aisle or by category.

In some embodiments, the system allows the use of auto sort on the shopping list, matching shopping items with the ideal route through the store. That is, not only are the items sorted by aisle; but the aisles in the list are sorted in the same order as the store layout.

In other embodiments, the items are sorted by category. FIG. 19B shows an example of a list sorted by category.

Allows real-time feedback on perishable food quality, such as produce, meat and fish—e.g. “The steaks are great at Store XYZ today.”

Incorporates virtual payment capabilities—scan at the end of trip, get all offers and instantly charge to a credit/debit card.

Provides advance notification by retailers to shoppers when items of interest are being delivered to a store—e.g., fresh autumn apples, cranberries, fresh baked bread etc.

Enables a feedback mechanism in which shopper can tell the retailer if they would like to see a specific item stocked in a particular store, or provide shopping experience feedback

Segmentation capabilities—marketers and retailers can segment and target shoppers based on information captured in the system.

Allows the phone's LED light/flash to be used as an optical signal generator that communicates with the store's POS scanners directly (rather than via reflected light from the scanner's lasers and the UPC code). The Phones LED flash/light provides a modulated signal that simulates the reflected light from a UPC bar being scanned by a POS system's laser. The communication between the phone and the POS scanner allows for promotional offers and digital/mobile coupons to be “redeemed” within the stores standard paper coupon redemption systems.

A system is provided for automating and streamlining consumer grocery shopping purchase processes and enabling targeted, immediately pre-purchase decision direct-marketing capability.

A system is provided for developing individual shopper preferences and matching with lowest available priced product basket that reflects preferences.

A system is provided for delivering highly targeted and situation-ally relevant/aware conditional promotional offers and advertising to a consumer shopping for groceries based on consumer basket, preferences, behavior, or demographics.

The system provides behavioral insight driven promotional targeting in a mobile system.

A system is provided for delivering location based promotional and advertising messaging in retail environment automated decision making mechanism for shoppers.

The system can find equivalent products and recommend better priced alternatives from within the set of equivalents. The system enables the user to simply select items they intend to purchase by category and the search function identifies the items that would be acceptable to that shopper based on past behavior and the actions of similar shoppers.

The system operates by analyzing all possible combinations of store specific product prices, store specials, and coupons and automatically recommending the best store to shop and the best items to buy to maximize savings from within an acceptable set of product alternatives.

The system enables users to compete and track their savings progress from within a network of self-identified peers.

The system is provided for identifying the lowest priced basket of goods, within a system of retail outlets, that best meets shopper preferences.

The system provides both database system and architecture for rapid, mobile, in-process delivery of the above capabilities.

The methods and system described herein may be at least partially embodied in the form of computer-implemented processes and apparatus for practicing those processes. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

Although the subject matter has been described in terms of exemplary embodiments, it is not limited thereto. Rather, the appended claims should be construed broadly, to include other variants and embodiments, which may be made by those skilled in the art.

1. A method for streamlining a shopper's shopping purchase-decision wherein the shopper has a set of predefined shopper's requirements for one or more items the shopper intends to purchase, said predefined shopper's requirements based on factors such as price, quality, usage requirements, product performance, total cost of ownership, and peer/expert reviews, the method comprising:
a. at a first computer remote from the shopper's mobile device (MD), receiving a first list and a store list from the MD, said first list having been created by the shopper and comprising the one or more items that the shopper intends to purchase, said store list identifying at least one store; wherein the one or more items of the first list range in specificity from at least a category level descriptor to a specific stock keeping unit (SKU), wherein the respective first list of items from each of the at least one store represents a respective basket at each of the at least one store;
b. for each of the stores on the store list, performing in the first computer at least one comparison calculation for each of the respective baskets, the comparison calculation being performed at the category level or a lower level, and identifying a second list for each basket, the second list consisting of a combination of SKU's, corresponding to the items in each basket, that is a best choice of an individual item or a group of items in each basket that satisfies the shopper's requirements;
c. after step (b), the first computer receiving from at least one computer implemented direct marketing campaign management system, one or more incentives, when available, and applying the one or more incentives that are applicable to said individual item or a group of items in each basket; and
d. after step (c), identifying a basket, among the baskets corresponding to each of the at least one store, that best satisfies the shopper's purchase requirements;
e. after step (d), transmitting to the MD an identification of the store that corresponds to the basket that best satisfies the shopper's requirements and the second list associated with said basket.

2. The method of claim 1, wherein the comparison calculations comprise selecting a specific SKU based on relative price and a specified quantity criteria from among a group of products identified as commercial substitutes for each other.

3. The method of claim 2, wherein the group of products are identified as commercial substitutes based on a shopper input and/or shopper preferences.

4. The method of claim 3, wherein the group of products are identified as commercial substitutes based on a shopper profile and a dynamically updated model of the shopper's behavior.

5. The method of claim 1, further comprising identifying a basket among the baskets corresponding to each of the at least one store, that best satisfies the shopper's requirements before step (c), and step (d) updates the basket that satisfies the shopper's requirements as a result of applying the one or more incentives in step (c).

6. The method of claim 1, wherein the application of the one or more incentives results in a change to the at least one combination of SKUs at the store that corresponds to the basket that best satisfies the shopper's requirements.

7. The method of claim 1, wherein the one or more incentives is determined based on the first list.

8. The method of claim 1, wherein the one or more incentives is based on at least one of the group consisting of demographic information of the user, user preferences, user behavior, user psychographics, historical user purchases, user location, user domicile, historical and modeled user responsivity, user or group price elasticity, user or group cross-price elasticity.

9. The method of claim 1, wherein the one or more incentives is based on past behavior or purchases at the store that corresponds to the basket that best satisfies the shopper's requirements.

10. The method of claim 1, further comprising:
transmitting at least one marketer promotional incentive (MI), when available, along with the second list, to the MD from the at least one computer implemented direct marketing campaign management system.

11. The method of claim 10 further comprising:
at the first computer, receiving from the MD data representing information on any of the at least one MI that are accepted by the shopper;
performing additional comparison calculations to incorporate the at least one MI that are accepted by the shopper and update the baskets;
identifying a basket, among the baskets corresponding to each of the at least one store, that best satisfies the shopper's requirements and defining a third list consisting of contents of the identified basket; and
transmitting the third list and an identification of the store that corresponds to the identified basket to the MD.

12. The method of claim 11, further comprising:
transmitting to the MD at least one in-store promotional incentive (ISI), when available, from the at least one computer implemented direct marketing campaign management system, triggered by a detection of proximity of the MD to the store that corresponds to the basket that best satisfies the shopper's requirements.

13. (canceled)

14. The method of claim 11, further comprising
at the first computer, receiving from the MD a signal indicating that the shopper is about to begin shopping at the store that corresponds to the basket that best satisfies the shopper's purchase requirements and
transmitting to the MD a revised display of the third list that is modified to allow the shopper to input an indication of whether an item on the third list has been added to a physical or virtual shopping cart.

15. The method of claim 14 wherein the revised display of the third list comprises displaying items on the third list sorted alphabetically, categorically, or by department, to facilitate a collection and purchase of the items on the third list at each individual one of the stores.

16. The method of claim 15, wherein displaying the items on the third list further includes displaying the items on the third list sorted by at least one of in-store location, aisle, shelf position, and store section.

17. The method of claim 14, wherein once the shopper inputs indications into the MD that every item on the third list has been added to the physical or virtual shopping cart or is done shopping, the MD displays or transmits a store frequent shopper card information of the user at a checkout station.

18. The method of claim 17, wherein the MD communicates frequent shopper card information to a point-of-sale (POS) system of the store, the method further comprising:
using the frequent shopper card information to facilitate fulfillment of the one or more incentives, MI or an in-store promotional incentive (ISI) and reduction of a final invoice charged to the shopper for the items of the third list.

19. The method of claim 18, wherein the fulfillment of the one or more incentives, MI and ISI is handled separately for the POS system, and fulfillment is executed by sending a direct cash payment to the shopper.

20. The method of claim 17, wherein the MD receives information and displays said information once the shopping is complete, the information representing savings achieved by purchasing the items on the third list at the store that corresponds to the basket that best satisfies the shopper's purchase requirements and a subtotal or running total of savings by the shopper at the same store or at all locations during performance of the method.

21. The method of claim 11, wherein the third list is transmitted to a store or third party for selection, packing and shipping to the user or pickup by the user.

22.-27. (canceled)

28. A system for streamlining a shopper's shopping purchase-decision, wherein the shopper has a set of predefined shopper's requirements for one or more items the shopper intends to purchase, said predefined shopper's requirements based on factors such as price, quality, usage requirements, product performance, total cost of ownership, and peer/expert reviews, the system including:
a programmed processor; and
at least one database accessible by the programmed processor;
wherein the programmed processor is configured to communicate with the shopper's mobile device (MD), the MD configured with a shopper module that provides an interface to be used by a shopper for creating a shopping list and a store list, said shopping list containing the one or more items that the shopper intends to purchase, and said store list identifying at least one store,
wherein the one or more items of the shopping list range in specificity from at least a category level descriptor to a specific stock keeping unit (SKU), wherein the shopping list of one or more items from each of the at least one store represent a respective basket at each of the at least one store,
wherein the shopper module is configured to transmit to the programmed processor the shopping list and the store list created by the shopper,
wherein the programmed processor is configured for performing at least one comparison calculation for each of the respective baskets, the comparison calculation being performed at the category level or a lower level, and identifying a revised shopping list for each basket, the revised shopping list consisting of a combination of SKU's, corresponding to the items in each basket, that is a best choice of an individual item or a group of items in each basket that best satisfies the shopper's requirements; and
at least one direct marketing campaign management system configured for maintaining one or more incentives, when available, in said at least one database,
wherein the programmed processor configured to communicate with the at least one direct marketing campaign management system,
wherein the programmed processor is configured to receive the one or more incentives, when available, from the at least one direct marketing campaign management system, apply the one or more available incentives that are applicable to said individual item or a group of items in each basket, and identifying a basket, among the baskets corresponding to each of the at least one store, that best satisfies the shopper's requirements, and transmit to the MD an identification of the store that corresponds to the basket that best satisfies the shopper's requirements and the revised shopping list associated with said basket while the shopper module is running, for presentation to the shopper on the MD.

29. The system of claim 28, wherein at least one of the one or more available incentives is a predetermined promotional offer, and the programmed processor is configured to transmit the predetermined promotional offer to the MD when the shopper exhibits a specified behavior.

30. The system of claim 28, wherein the one or more available incentives are based on one of the group consisting of shopper demographics and shopper behavior, psychographics, historical purchases, past retail preferences, preferences, responsivity, location, basket contents, list contents, related or complementary items for list items or a offers business or competitive strategy.

31. The method of claim 1, wherein at least one of the one or more incentives is a predetermined promotional offer, and the computer implemented direct marketing campaign management system is configured to transmit the predetermined promotional offer to the MD when the shopper exhibits a specified behavior.

32. The method of claim 1, wherein at least one of the one or more incentives is a predetermined advertisement and the computer implemented direct marketing campaign management system is configured to transmit the predetermined advertisement to the MD when the shopper exhibits a specified behavior.

33. The method of claim 1, wherein the store list has one store and the method further comprising: identifying a list of items containing a set of respective SKU level item descriptors that represent commercial substitutes for at least some of the items on the first list.

34. The method of claim 1, wherein the shopper's requirements is lowest total basket cost and said at least one comparison calculation performed in step b) identifies a combination of SKU's, corresponding to the items in each basket, that is the best choice of an individual item or a group of items in each basket that provides the lowest total basket cost for each basket.

35. The system of claim 28, wherein at least one of the one or more incentives is a predetermined promotional offer and the programmed processor is configured to transmit the predetermined promotional offer to the MD when the shopper exhibits a specified behavior.

36. The system of claim 28, wherein at least one of the one or more incentives is a predetermined advertisement and the programmed processor is configured to transmit the predetermined advertisement to the MD when the shopper exhibits a specified behavior.

37. The system of claim 28, wherein the shopper's requirements is lowest total basket cost and said at least one comparison calculation identifies a combination of SKU's, corresponding to the items in each basket, that is the best choice of an individual item or a group of items in each basket that provides the lowest total basket cost for each basket.
